(19) United States
(12) Patent Application Publication
(10) Pub. No.: US 2015/0330558 A1
(43) Pub. Date: Nov. 19, 2015

(54) INTEGRATED PORTABLE STAND, POWER SUPPLY, AND CONTROL PANEL

(71) Applicant: AIR SYSTEMS, INC. dba AIR SYSTEMS INTERNATIONAL, INC., Chesapeake, VA (US)

(72) Inventor: Lawrence Shane Intravatola, Chesapeake, VA (US)

(21) Appl. No.: 14/810,387

(22) Filed: Jul. 27, 2015

Related U.S. Application Data
(63) Continuation-in-part of application No. 14/094,765, filed on Dec. 2, 2013.
Application No. 14/094,765 is a division of application No. 12/432,525, filed on Apr. 29, 2009, now Pat. No. 8,599,097.
Application No. 12/432,525 is a continuation-in-part of application No. 13/376,156, filed on Mar. 23, 2012, now Pat. No. 9,103,495.
(60) Provisional application No. 61/053,229, filed on May 15, 2008.
(60) Provisional application No. 61/183,950, filed on Jun. 3, 2009.

(51) Int. Cl. F16M 11/24; F16M 11/34; F21V 27/00; F21V 21/22; F21V 21/06; F16M 11/28; F21L 4/02

(52) U.S. Cl. CPC F16M 11/24; F16M 11/28; F16M 11/34; F21L 4/02; F21V 21/22; F21V 21/06; F21V 27/005

(57) ABSTRACT

A portable stand includes a supporting frame, wherein the supporting frame has a base assembly operatively connected to at least one extendible leg for movement about a pivotal axis. The base assembly includes a base plate adapted for attachment to an interior of a case. The supporting frame also includes a telescoping mast assembly having a mast support bracket assembly adapted for attachment to the interior of the case. The telescoping mast assembly is operatively connected to a telescopically extendible mast for selective retraction of said extendible mast for storage inside of the interior of the case. The mast further includes a mount for at least one functional device. The mount permits a functional device attached thereto to have multiple degrees of freedom of motion.

### CROSS REFERENCE TO RELATED APPLICATIONS

This application is a continuation-in-part of U.S. patent application Ser. No. 14/094,765, filed Dec. 2, 2013, entitled “COLLAPSIBLE PORTABLE STAND WITH TELESCOPING SUPPORT AND INTEGRAL STORAGE CASE”, which is currently pending, which is a division of U.S. patent application Ser. No. 12/432,525, filed Apr. 29, 2009, entitled “COLLAPSIBLE PORTABLE STAND WITH TELESCOPING SUPPORT AND INTEGRAL STORAGE CASE”, which is now U.S. Pat. No. 8,599,097, which claims priority of U.S. Provisional Patent Application Ser. No. 61/053,229, entitled “COLLAPSIBLE PORTABLE STAND WITH TELESCOPING SUPPORT AND INTEGRAL STORAGE CASE”, filed May 15, 2008, and this application is a continuation-in-part of U.S. patent application Ser. No. 13/376,156, entitled “INTEGRATED PORTABLE STAND, POWER SUPPLY, AND CONTROL PANEL,” filed Mar. 23, 2012, which is currently pending, which is a national phase filing under 35 USC 371 of PCT/US10/37342, entitled “INTEGRATED PORTABLE STAND, POWER SUPPLY, AND CONTROL PANEL,” filed Jun. 3, 2010, which claims the benefit of U.S. Provisional Patent Application Ser. No. 61/183,950, entitled “INTEGRATED PORTABLE STAND, POWER SUPPLY, AND CONTROL PANEL,” filed Jun. 3, 2009.

### BACKGROUND OF THE INVENTION

1. Field of the Invention

The present invention relates to stands for supporting items in an elevated position with respect to the surroundings. More specifically, the invention relates to stands that are portable, easy to set up for use at site, easy to collapse for storage and transport, and that do not require connection of parts at a site of use to function nor disconnection of any parts after use in order to collapse the stand for storage and transport.

2. Description of the Related Art

While prior stands offer a variety of benefits, there remains a need for a stand that comprises an integrated power supply and controls. In addition, there remains a need for a stand that is robust, easy to set up and collapse, is self-contained, and yet can be made economically and with a minimal number of complex parts.

The need for temporary stands to support items at an elevated position with respect to their surroundings is ubiquitous. For example, temporary lighting is a common functional device that is required for dark and remote job sites. However, if there are multiple parts that need to be connected in the dark in order to set up a platform, work is delayed, injuries may occur and parts may be lost and/or not available at all. Even if there is light, a stand that is not self-contained and that requires connection of parts to erect for use may cause delays in the start of work at the job site while workers attempt to locate the various parts and piece the parts together.

It is further appreciated, stands are often used “on site” and dirt, mud, rocks and other materials may become lodged in the supporting structure of a stand. As such, any stand which is intended for outdoor use at remote job sites must be constructed in a manner ensuring the support structure will not be rendered nonfunctional or clogged by various environmental factors which may be encountered. Therefore, legs which may be mounted at the bottom of a housing would not be desirable because after the first time the housing is used on mud, etc., the mud can interfere with operation of the legs of the supporting structure.

It is appreciated that microphones, podium platforms, loudspeakers, cameras, sensors, and surveying equipment are some of only a wide variety of functional devices that require support by a stand and that would benefit from a stand that may be quickly collapsed for storage and transport. Further, a portable stand for different functional devices may be required for use at various locations over time. For example, a road crew that works at night may need to use a light stand and many other pieces of equipment.

As a result, a stand of small size, low weight and convenient set up and collapse is desired. The stand must also be robust for repetitive use, rough handling and corrosive environments. For use in dangerous environments, the stand and its components should be intrinsically safe. When deployed, the stand should be stable under expected conditions of use. For example, a stand for holding a work light should not tip over when set up in a location where there are strong winds and/or where it may be jostled by surrounding people and equipment. Job sites that have explosives, fire, or other safety hazards also require equipment to be intrinsically safe.

### SUMMARY OF THE INVENTION

It is, therefore, an object of the present invention to provide a portable stand including a plastic case that defines an enclosed space and having at least two sides, a mast operatively connected to the case, a mast mount for attaching at least one functional device to the mast, and extendible and retractable first and second legs. The first and second legs both are operatively connected to at least one of the two sides of the case so that the first and second legs can be locked in a retracted or extended position. The mast is operatively connected to one of the at least two sides of the case such that the mast is selectively extended and retracted from the case. The case provides the enclosed space in which a power supply and a control panel can be contained, wherein when present the power supply comprises a battery. The mast mount is operatively connected to the mast, wherein the first and second legs may be retracted for transport and storage and the mast can be retracted for transport and storage. The first and second legs and the mast are extendable from the case at a site of use by manipulation of the first and second legs and the mast without requiring connection of parts thereto. The mast can be extended vertically from the case and the first and second legs can be extended horizontally from the case. The case forms a third leg of a tripod in conjunction with the first and second legs when the first and second legs are in their horizontally extended position providing stability for the mast when the mast is extended vertically upwards from the case.

It is also an object of the present invention to provide a portable stand including a supporting frame. The supporting frame includes a base assembly operatively connectable to at least one extendible leg for movement of the at least one leg, when connected, about a pivotal axis. The base assembly comprises a base plate operatively connectable to an interior of a case. At least one extendible leg can be individually and pivotally attached to the base plate for selective retraction for storage inside of the interior of a case to which the base plate is attached, and the base plate comprises a releasable locking member for controlling angular orientation of at least one extendible leg when operatively connected to the base assembly. The portable stand also comprises a telescoping mast assembly having a mast support bracket assembly operatively connectable to the interior of a case. The telescoping mast assembly is operatively connectable to a telescopically extendible mast so that when a mast is connected the mast can be selectively retracted for storage inside of the interior of a case. The mast support bracket assembly comprises a releasable locking member for controlling angular orientation of the telescopically extendible mast when operatively connected to a mast mount for at least one functional device. When at least one extendible leg is attached to the base assembly, the at least one leg can be pivoted about 90 degrees with respect to the base assembly and a telescopically extendible mast, when attached to the telescoping mast assembly, can be pivoted about 180 degrees with respect to the telescoping mast assembly. When the telescopically extendible mast, when present, is pivoted inward toward the base assembly and the at least one extendible leg, when present, is pivoted inward toward the telescoping mast assembly a cover on the case can be closed to enclose the at least one extendible leg and the telescoping mast assembly within the interior of the case.

It is further an object of the present invention to provide a portable stand comprising a case that defines an enclosed space in which a power supply and a controller are mounted. The stand also comprises a mount for attaching at least one functional device, as well as extendible and retractable first and second legs pivotally attached to the case for rotation about a substantially horizontal axis. The first and second legs are attached to the case so that the first and second legs can be locked in a retracted position for transport and storage or an extended position for use at a site of operation. The case forms a third leg of a tripod in conjunction with the first and second legs when the first and second legs are in their extended position. The portable stand also comprises an extendible mast to which the mount is connected, the extendible mast being attached to the case such that the extendible mast can be retracted for transport and can be extended vertically upwards from the case.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of a first exemplary embodiment of a collapsible portable stand of the present invention with extendible legs, a telescoping support and an integral storage case, shown at ⅛ scale (all scales provided are based on reproduction on 8.5″×11″ paper, but are exemplary as device can be of varying size).

FIG. 2 is a perspective view of the collapsible portable stand of FIG. 1 in which the extendible legs and the extendible telescoping support have been retracted and folded into the integral storage case (⅙ scale).

FIG. 3 is a perspective view of the collapsible portable stand of FIG. 2 demonstrating closure and securing of the exterior case storage case door (⅙ scale).

FIG. 4 is a partially exploded perspective view of the collapsible portable stand of FIG. 1 (⅛ scale).

FIG. 5 is a perspective view of the inner case assembly shown in FIG. 4 (⅙ scale).

FIG. 6 is a perspective view of the inner case assembly shown in FIG. 5 that includes an exploded perspective view of telescoping leg assemblies included in the inner case assembly (⅕ scale).

FIG. 7 is a perspective view of an inner mount case and base assembly shown in FIG. 6 (¼ scale).

FIG. 8 an exploded perspective view of the base assembly shown in FIG. 6 (⅙ scale).

FIG. 9 a perspective view of the leg base plate shown in FIG. 8 (¼ scale).

FIG. 10 a flat pattern for making the leg base plate shown in FIG. 9 (¼ scale).

FIG. 11 is a perspective view of the leg base inner flange, right side, shown in FIG. 8 (¼ scale).

FIG. 12 is a perspective view of the leg base inner flange, left side, shown in FIG. 8.

FIG. 13 is a flat pattern for making the left leg base inner flange and right leg base inner flange shown in FIG. 11 and FIG. 12.

FIG. 14 is a perspective view of the inner mount case shown in FIG. 8 (¼ scale).

FIG. 15 a flat pattern for making the inner mount case shown in FIG. 14.

FIG. 16 is an exploded perspective view of the first leg segment and spring pin assembly shown in FIG. 6.

FIG. 17 is an exploded perspective view of the second leg segment and spring pin and rubber foot assembly shown in FIG. 6.

FIG. 18 a plan view of the first leg segment shown in FIG. 16.

FIG. 19 a plan view of the second leg segment shown in FIG. 17.

FIG. 20 is an exploded perspective view of the telescoping mast support assembly shown in FIG. 4.

FIG. 21 is a top perspective view of the mast pivot support assembly shown in FIG. 20 (⅓ scale).

FIG. 22 is a bottom perspective view of the mast pivot support assembly shown in FIG. 20.

FIG. 23 is side view of the mast pivot support assembly of FIG. 20 in a locked “UP” position (½ scale).

FIG. 24 is side view of the mast pivot support assembly of FIG. 20 in a locked “DOWN” position.

FIG. 25 is an exploded perspective view of the mast pivot support assembly of FIG. 20 (⅓ scale).

FIG. 26 is an exploded perspective view of the mast support top assembly shown in FIG. 25.

FIG. 27 is a perspective view of the mast support top plate shown in FIG. 26.

FIG. 28 is a plan view of a mast pivot guide shown in FIG. 26.

FIG. 29 is a perspective view of the mast support bracket assembly shown in FIG. 25 (¼ scale).

FIG. 30 is a perspective view of the mast support bracket shown in FIG. 29.

FIG. 31 is a flat pattern for making the mast support bracket shown in FIG. 30.

FIG. 32 is a plan view of the mast support bracket bottom plate shown in FIG. 29.

FIG. 33 is a perspective view of the mast pivot lock pull handle shown in FIG. 25.

FIG. 34 is a perspective view of the mast clamp shown in FIG. 20.

FIG. 35 is a front plan view of a second exemplary embodiment of a collapsible portable stand with extendible legs, a telescoping support and an integral storage case that has been equipped with a hinged lighting control system (⅜ scale).

FIG. 36 is a top-angled perspective front view of the collapsible portable stand shown in FIG. 35 ( 3/16 scale).

FIG. 37 is a top-angled perspective front view of the collapsible portable stand shown in FIG. 36 in which the hinged lighting control system panel has been placed in an open position.

FIG. 38 is a front elevation view of the collapsible portable stand shown in FIG. 37 (⅜ scale); the inner control panel or cover for the interior case is shown in an open position.

FIG. 39 is a top-angled perspective front view of the lighting control system shown in FIG. 35 (¼ scale), which is incorporated into the cover panel for the interior case.

FIG. 40 is a top-angled perspective rear view of the lighting control system shown in FIG. 35.

FIG. 41 is a front elevation view of the lighting control system shown in FIG. 35.

FIG. 42 is a side elevation view of the lighting control system shown in FIG. 35.

FIG. 43 is a top-angled perspective front view of the collapsible portable stand shown in FIG. 36 that demonstrates the degrees of freedom of motion supported by the leg assemblies and telescoping support of the portable stand.

FIG. 44 is a top-angled perspective front view of the collapsible portable stand shown in FIG. 43 in which the leg assemblies and telescoping support have been contracted and folded into the integral storage case.

FIG. 45 is a top-angled perspective front view of a third exemplary embodiment of a collapsible portable stand with extendible leg assemblies, a telescoping support and an integral storage case, in which a lighting assembly has been attached to the extended telescoping support.

FIG. 46 is a top-angled perspective front view of the collapsible portable stand shown in FIG. 45 in which the leg assemblies, telescoping support and lighting assembly have been contracted and folded into the integral storage case.

FIG. 47 is a top-angled perspective front view of the lighting assembly of FIG. 46, shown in a folded configuration.

FIG. 48 is a top-angled perspective front view of the lighting assembly of FIG. 46, shown in an open/expanded configuration.

FIG. 49 is a top-angled perspective front view of the assembly of FIG. 46 in which the degrees of freedom of motion for functional devices (e.g., lights attached to the mount) are demonstrated in this example with changing the configuration of the lighting system from the folded configuration of FIG. 47 to the open/expanded configuration of FIG. 48.

FIG. 50 is an exploded top-angled perspective front view of the mounts with lights shown in FIG. 49.

FIG. 51 is a top-angled front perspective view of a fourth exemplary embodiment of a collapsible portable stand with telescoping support.

FIG. 52 is a top-angled rear perspective view of the collapsible portable stand shown in FIG. 51.

FIG. 53 is a top-angled rear perspective view of the collapsible portable stand of FIG. 51 configured with the leg assemblies and telescoping support fully extended with a lighting assembly mounted on the extended telescoping support.

FIG. 54 is a top-angled perspective view of a fifth exemplary embodiment of a collapsible portable stand with telescoping support.

FIG. 55 is a top-angled perspective view of the collapsible portable stand of FIG. 54 configured with the leg assemblies and telescoping support fully extended.

FIGS. 56 to 59 are, respectively, a front top perspective view of a further embodiment of the stand with the telescoping arm assembly in the foreground, a front top perspective view of the stand with the collapsed or retracted leg assembly in the foreground, a rear top perspective view of the stand with the collapsed leg assembly in the foreground, and a side elevation view with the telescoping assembly in the foreground.

FIG. 60 is a front top perspective view of the stand with the leg assembly extended and in the foreground.

FIGS. 61 and 62 are, respectively, a top side perspective view of the isolated leg assembly in an extended configuration and in a collapsed configuration.

FIG. 63 is an exploded view of the leg assembly and its components.

FIG. 64 is a front top perspective view of the isolated telescoping arm assembly with a functional device fitting, including a variation of the height adjustment hardware.

FIG. 65 is a bottom front perspective view of the isolated telescoping assembly of FIG. 64.

FIG. 66 is an exploded view of the functional device fitting showing how multiple functional devices, in this case lights in cube shaped housings, can be mounted thereto along with a wiring diagram. A single or double light can be pivotally mounted between the legs of an h-shaped bracket, with the opposite end of the h-shaped bracket being pivotally mounted to the main body of the fitting; in this way a light in one bracket can be pivoted up and down while the h-shaped bracket can rotate about its connection to the main body of the fitting.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

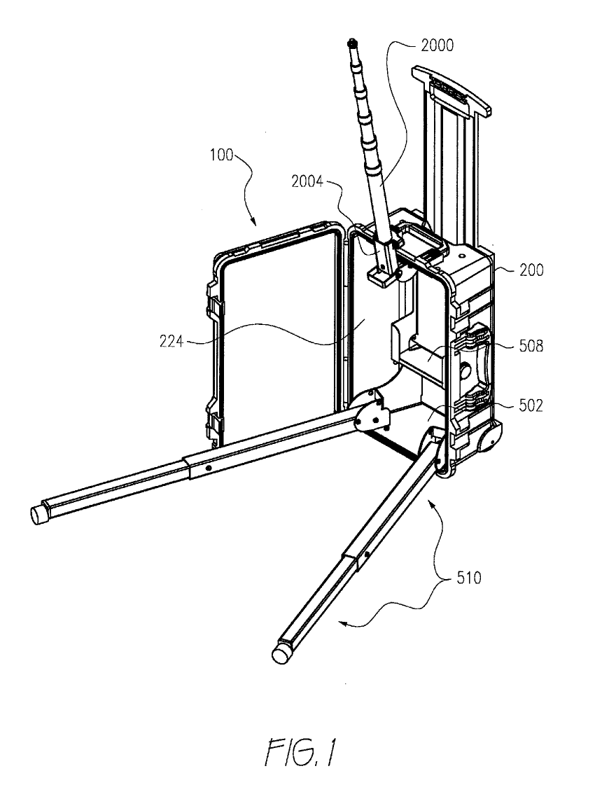

Similar reference numerals are used in different figures to denote similar components. The following provides further details of the present inventions summarized above and illustrated in the Figures. Referring to FIGS. 1-66, exemplary embodiments of assembled collapsible portable stands with extendable masts, their components and their assembly are illustrated.

FIG. 1 is a perspective view of a first exemplary embodiment of a collapsible portable stand of the present invention with extendible legs, a telescoping mast or support for a functional device and an integral storage case shown at ⅛ scale. The scale is provided to understand relative dimensions of parts of preferred exemplary embodiments illustrated and described herein. The scale used in particular Figures has been provided above in the description of the Figures. However, the scales used herein should not be deemed as limiting since larger and smaller embodiments are envisioned to be within the scope of the invention. Functional devices that may be operatively attached to the mast include but are not limited to one or more of lights, microphones, surveying equipment, still cameras, video cameras, microwave communication devices, radiofrequency and/or electromagnetic communication devices, chemical sensors, thermal sensors, motion sensors, an alarm, a speaker, a monitor or other audio and/or visual output, weather detection devices, solar and/or wind power generator, a GPS (global positioning system) device, and a taser or other weapon. Functional devices may include controls and mechanisms to direct same.

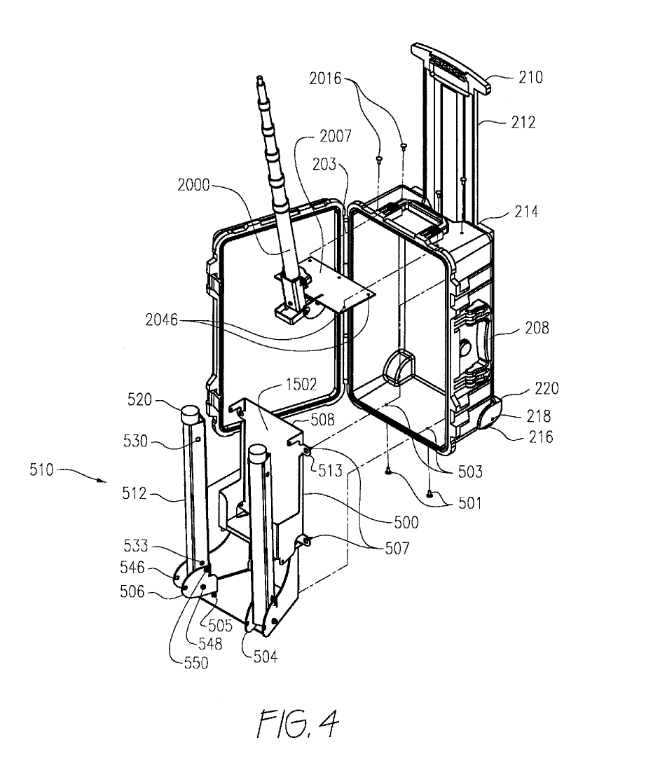

Referring to FIGS. 1-5, stand 100 includes an integral storage case 200, a telescoping mast assembly 2000 and an inner case assembly 500 (isolated in FIG. 4) that includes a base assembly 502, an inner mount case 508, a first and second telescoping leg assemblies 510. Telescoping mast assembly 2000 mounts to an upper interior face of case 200. Base assembly 502 is mounted to a bottom interior face 222 of case 200. Inner mount case 508 rests on top of base assembly 502 and mounts to a back interior face of case 200.

A junction between base assembly 502 and a telescoping leg assembly 510 includes a pivot, or hinge, that allows a telescoping leg assembly 510 to be locked at different positions relative to the hinge. In a first position, the leg assembly extends from an interior space 224 of case 200, e.g., in a plane substantially parallel to a plane of the bottom interior face of case 200. In a second position, the telescoping leg assembly may remain, when fully retracted, within interior space 224 of case 200.

Telescoping mast assembly 2000 includes a mast pivot support assembly 2004 that allows telescoping mast assembly 2000 to be locked at different positions relative to the mast pivot support assembly. In a first position, telescoping mast assembly 2000 extends from interior space 224 of case 200, e.g., in an upward direction away from case 200. In a second position, telescoping mast assembly 2000 extends downwards and remains, when fully contracted, within interior space 224 of case 200. A suitable telescoping tubular mast for this embodiment can be of aluminum having a maximum diameter of about 1 & ½ inch, such as for example, a mast acquired from Testrite Visual Products, Inc. of Hackensack, N.J. When the mast is vertically extended above the case to its maximum height, a functional device can be elevated about 96 inches above the base of the case. However, masts of other materials and dimensions may be used depending on the desired use. Preferably, for the subject embodiment, the case with its cover, legs, and mast weighs less than about 25 pounds.

In a preferred embodiment, the device of FIGS. 1-5 has a case body (not including the door), having outer dimensions with a height of about 22″, a width of about 14″, and is about 7″ deep. The legs can pivot out to extend about 18″ from the case body, further telescoping out to about 32″ (or in another embodiment the legs can be unfolded to extend further). The angle that the legs project from the case walls and from each other may vary depending on the case features. It is envisioned that the angle and connections of the legs to the case can be adjustable in some embodiments; for example, the leg pivots may be slidably connected to the case base via captured wingnuts set in elongated slots that permit relative motion without detachment. While hollow square stainless steel tubes are a preferred material for forming the legs, other materials and leg shapes may be used. In the embodiment of FIGS. 1-5, the outer leg segments are formed of 1 & ½″ square tubing and the inner leg segments that fit into the outer leg segments are of 1 & ¼″ square tubing.

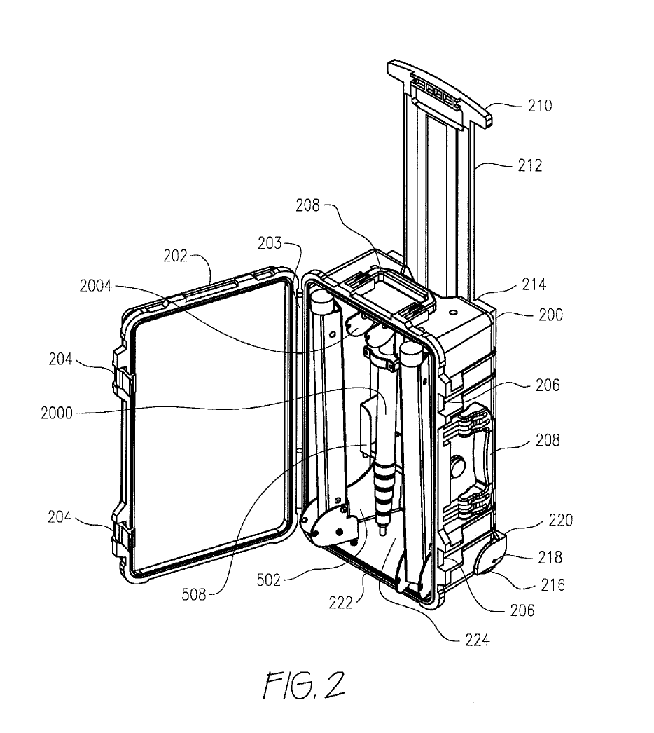

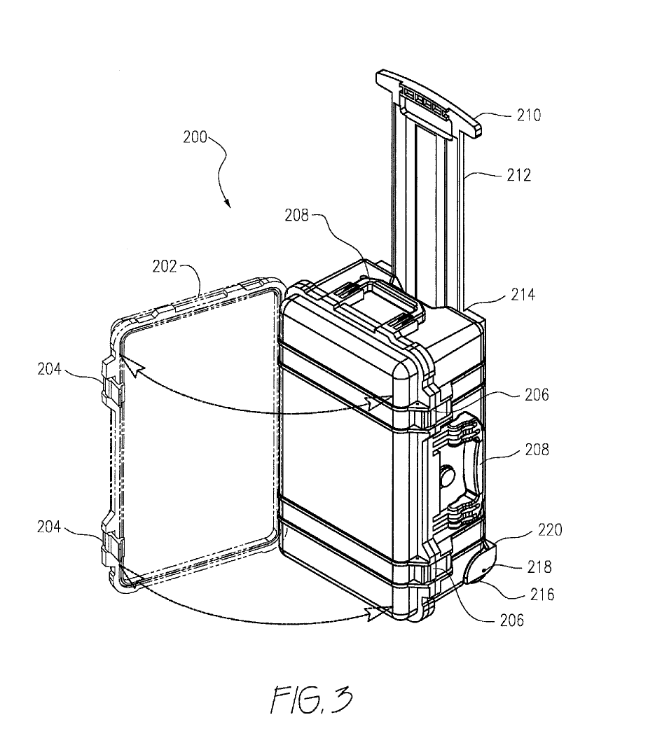

FIG. 2 is a perspective view of the collapsible portable stand of FIG. 1 in which the extendible legs and the extendible telescoping support have been retracted and folded into the integral storage case. Specifically, each telescoping leg assembly 510 has been retracted and folded at the pivot with base assembly 502 into interior space 224 of case 200. Further, the telescoping mast of telescoping mast assembly 2000 has been retracted, and the mast has been folded at the pivot of the mast pivot support assembly 2004 into interior space 224 of case 200. In an alternative embodiment, the mast may have an infinitely adjustable pivot angle, which may be accomplished for example by using captured wing nuts set in elongated grooves in the mount.

As further shown in FIG. 2, case 200 includes an exterior door 202 that is connected to case 200 at a hinge 203. When placed in a closed position, a male clasp 204 on exterior door 202 aligns with and locks onto a female clasp 206 on case 200, thereby securing exterior door 202 to case 200. Case 200 further includes a lift handle 208 on one or more exterior faces of case 200 to facilitate lifting case 200 by one or more persons.

In addition, case 200 includes one or more wheels 216 and a towing handle 210 that allows case 200 to be towed on the one or mote wheels. For example, as shown in FIG. 2, a wheel 216 attaches to case 200 at axel 218 and is protected by a wheel guard 220. Towing handle 210 includes a slide 212 that fits into a track 214 in case 200, thereby allowing towing handle 210 to retract into case 200 when not in use.

FIG. 3 is a perspective view of the collapsible portable stand of FIG. 2 in which the exterior storage case door is shown in both an open and a closed/locked position.

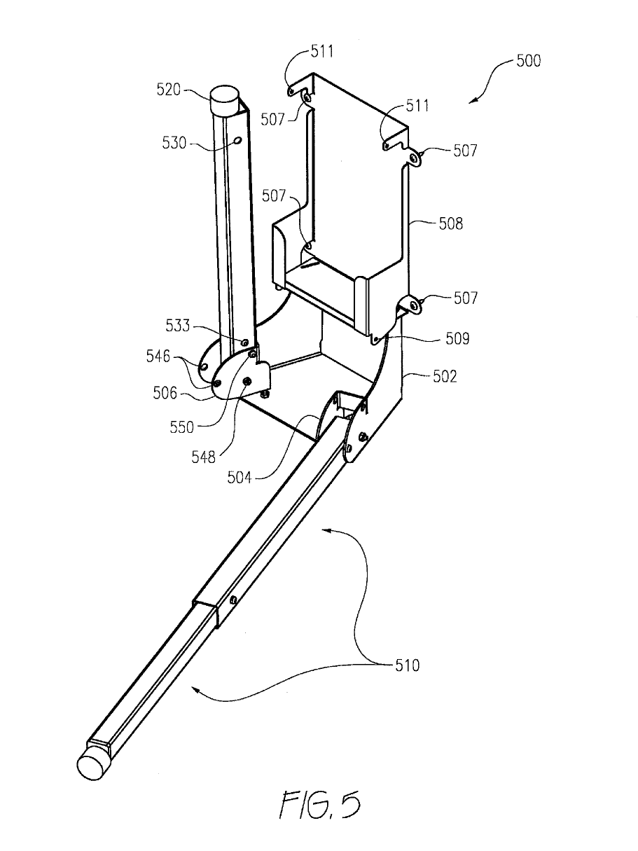

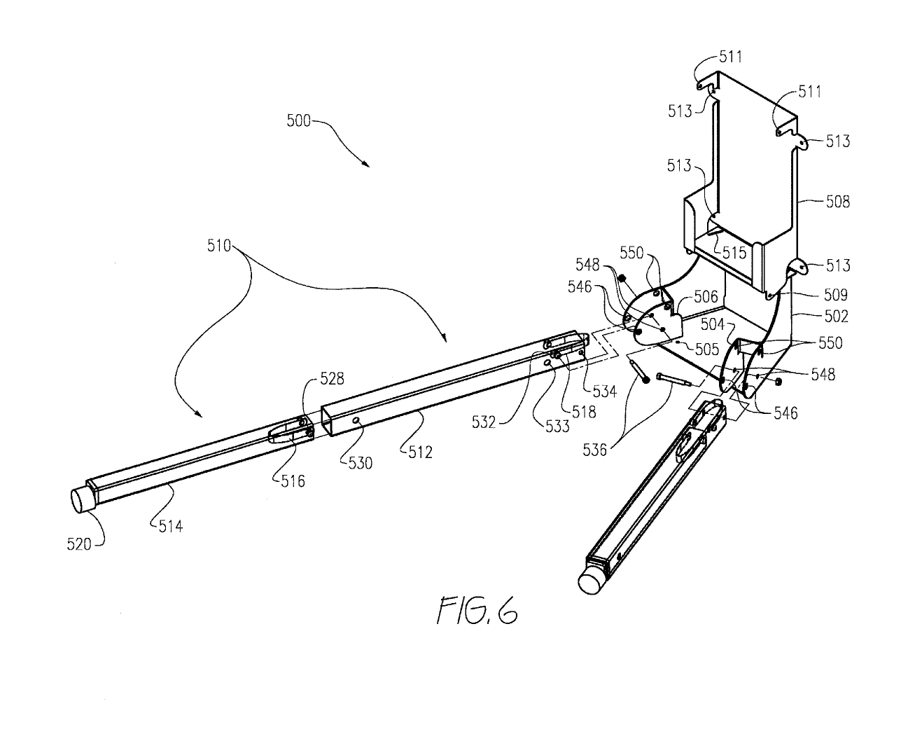

FIG. 4 is a partially exploded perspective view of the collapsible portable stand of FIG. 1. FIG. 5 is a perspective view of inner case assembly 500, as shown in FIG. 4. FIG. 6 is a perspective view of inner case assembly 500 that includes an exploded perspective view of the respective telescoping leg assemblies.

As shown in FIGS. 4 and 5, holes 505 in a base plate of base assembly 502 are aligned with holes 503 in a bottom interior face of case 200, thereby allowing base assembly 502 to be secured to the bottom interior face of case 200 with fasteners 501. Holes 513 in back plate 1502 of inner mount case 508 are aligned with holes in a back interior face of case 200, thereby allowing inner mount case 508 to be secured to the back interior face of case 200 with fasteners 507. Holes 2046 in mast assembly mounting plate 2007 of telescoping mast assembly 2000 are aligned with holes in an upper interior face of case 200, thereby allowing telescoping mast assembly 2000 to be secured to the upper interior face of case 200 with fasteners 2016.

As further shown in FIG. 5 and FIG. 6, a telescoping leg assembly 510 includes a first leg segment 512 that receives a second leg segment 514 that is secured at one of two positions within first leg segment 512. For example, second leg segment 514 is fixed at an extended position relative to first leg segment 512 by aligning and engaging protruding pins of spring pin 516 with through holes 530 in first leg segment 512. Second leg segment 514 is fixed at a retracted position relative to first leg segment 512 by aligning and engaging protruding pins of spring pin 516 with through holes 533 in first leg segment 512.

As further shown in FIG. 5 and FIG. 6, a telescoping leg assembly 510 is attached to base assembly 502 by aligning through holes 534 in first leg segment 512 with through holes 548 in base assembly 502 and fastening bolt 536 through the aligned holes. Once telescoping leg assembly 510 has been attached to base assembly 502, telescoping leg assembly 510 may be set in a first, or extended position, by pivoting telescoping leg assembly 510 on bolt 536 to align and engage protruding pins of spring pin 518 with through holes 546 in base assembly 502, as shown with a first leg assembly in FIG. 5. Telescoping leg assembly 510 may be set in a second, or folded position, by pivoting telescoping leg assembly 510 on bolt 536 to align and engage protruding pins of spring pin 518 with through holes 550 in base assembly 502, as shown with a second leg assembly in FIG. 5.

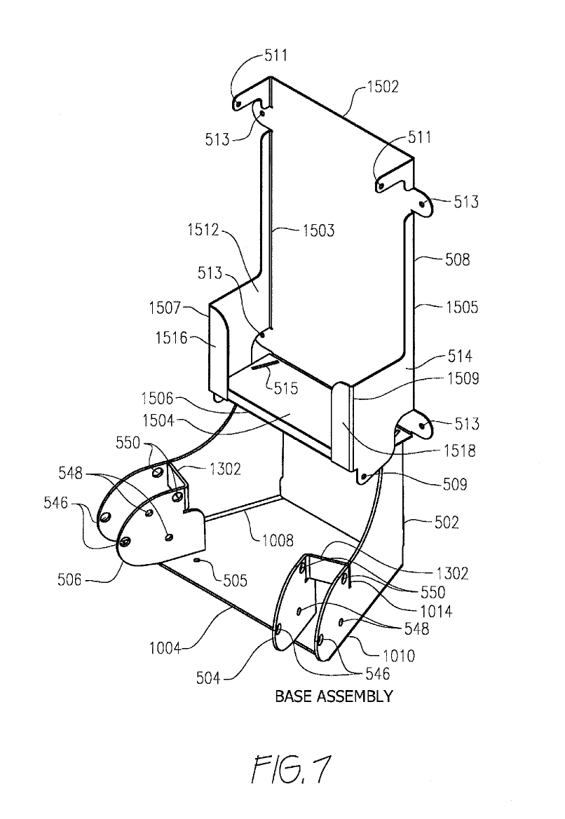

FIG. 7 is a perspective view of base assembly 502 joined to inner mount case 508, as shown in FIG. 6. FIG. 8 is an exploded perspective view of base assembly 502 and inner mount case 508, as shown in FIG. 7.

As shown in FIG. 7 and FIG. 8, base assembly 502 is formed by joining a leg base plate 503 to a right side leg base inner flange 504 and a left side leg base inner flange 506. For example, a bottom tab 1304 and a spacer tab 1302 of right side leg base inner flange 504 are inserted and secured into slot 1018 and slot 1014 of leg base plate 503, respectively. Further, a bottom tab 1304 and a spacer tab 1302 of left side leg base inner flange 506 are inserted and secured into slot 1016 and slot 1012 of leg base plate 503, respectively. Inner mount case 508 is secured to base assembly 502 by inserting and securing top tab 1020 and top tab 1022 of base assembly 502 into a respective slot 515 in inner mount case 508

FIG. 9 is a perspective view of leg base plate 503 of the base assembly 502 shown in FIG. 8. FIG. 10 shows a flat pattern 1000 for making the leg base plate 503 as shown in FIG. 9. Base plate 503 may be fabricated from a sheet of metal that has been cut, e.g., with a metal saw, metal cutting stamp or metal cutting laser.

As shown in FIG. 10, a piece of sheet metal cut in accordance with pattern 1000 includes a left side 1002, a base 1004, and a right side 1006. Left side 1002 is separated from base 1004 by a fold line 1008. Right side 1006 is separated from base 1004 by a fold line 1010.

Left side 1002 includes top tab 1020, slot 1012, through hole 546, through hole 548, and through hole 550. Base 1004 includes slot 1016, slot 1018 and base holes 505. Right side 1006 includes top tab 1022, slot 1014, through hole 546, through hole 548, and through hole 550. Folding left side 1002 and right side 1006 upwards 90 degrees from base 1004 along fold line 1008 and along fold line 1010, respectively, results in a leg base plate 503, as shown in FIG. 8 and FIG. 9.

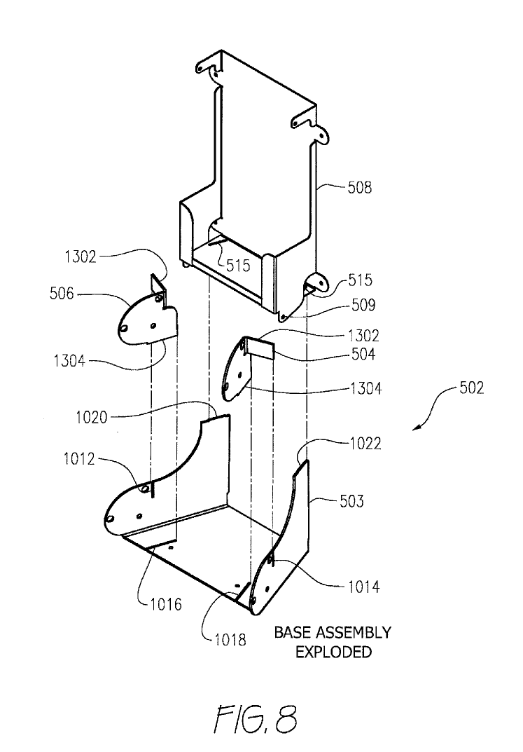

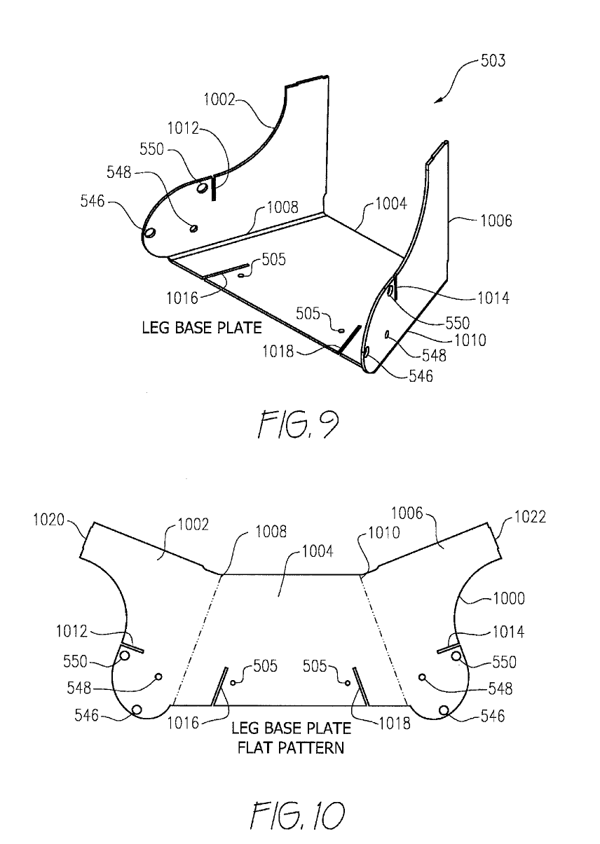

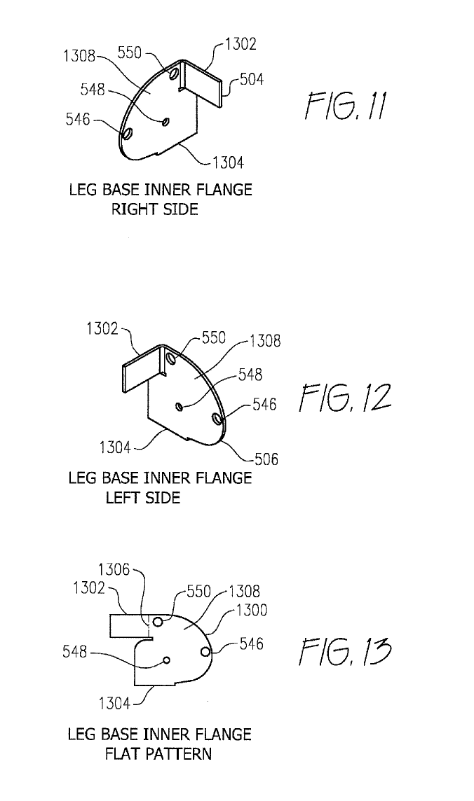

FIG. 11 is a perspective view of the leg base inner flange, right side, shown in FIG. 8. FIG. 12 is a perspective view of the leg base inner flange, left side, shown in FIG. 8. FIG. 13 is a flat pattern for making the left leg base inner flange and right leg base inner flange shown in FIG. 11 and FIG. 12.

A right side leg base inner flange 504 and a left side leg base inner flange 506 may be fabricated from a sheet of metal that has been cut, e.g., with a metal saw, metal cutting stamp or metal cutting laser, in the shape, or pattern, shown in FIG. 13 at 1300. As shown in FIG. 13, a piece of sheet metal cut in accordance with pattern 1300 includes a spacer tab 1302, a fold line 1306, a main flange body 1308 and a bottom tab 1304. Main flange body 1308 includes through hole 546, through hole 548, and through hole 550.

As shown in FIG. 11 and FIG. 12, folding spacer tab 1302 ninety degrees in a first direction relative to a plane of main flange body 1308 results in a right side leg base inner flange 504; folding spacer tab 1302 ninety degrees in a second direction relative to a plane of main flange body 1308 results in a left side leg base inner flange 506.

FIG. 14 is a perspective view of the inner mount case 508 shown in FIG. 8. FIG. 15 is a flat pattern 1500 for making the inner mount case 508 shown in FIG. 14. Inner mount case 508 may be fabricated from a sheet of metal that has been cut, e.g., with a metal saw, metal cutting stamp or metal cutting laser, in the shape, or pattern, shown in FIG. 15 at 1500.

As shown in FIG. 15, a piece of sheet metal cut in accordance with pattern 1500 includes a left front side 1516, a left side 1512, a left upper flange 1508, a back side 1502, a bottom side 1504, a front lip 1506, a right upper flange 1510, a right side 1514, and a right front side 1518. Left front side 1516 is separated from left side 1512 by fold line 1507. Left side 1512 is separated from back side 1502 by fold line 1503. Left upper flange 1508 is separated from back side 1502 by fold line 1501. Bottom side 1504 is separated from back side 1502 by fold line 1511. Right upper flange 1510 is separated from back side 1502 by fold line 1515. Right side 1514 is separated from back side 1502 by fold line 1505. Right front side 1518 is separated from right side 1514 by fold line 1509. Front lip 1506 is separated from bottom side 1504 by fold line 1513.

Left side 1512 and right side 1514 each include a through hole 509. Left upper flange 1508 and right upper flange 1510 each include a through hole 511. Back side 1502 includes through holes 513. Bottom side 1504 includes slots 515. Folding each identified side and each identified flange along the respective identified fold lines in a common direction towards back side 1502 results in an inner mount case 508, as shown in FIG. 7, FIG. 8 and FIG. 14.

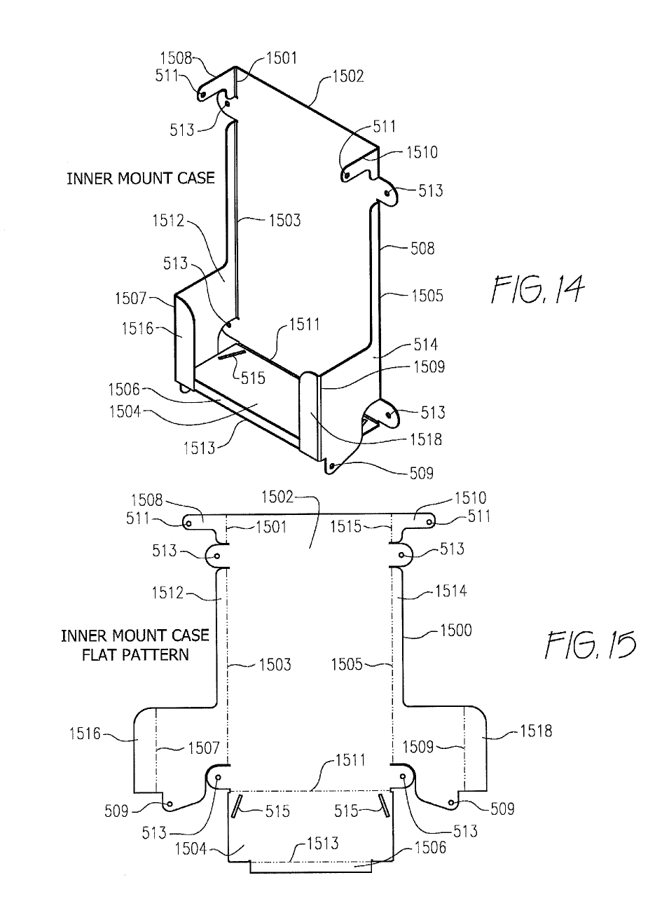

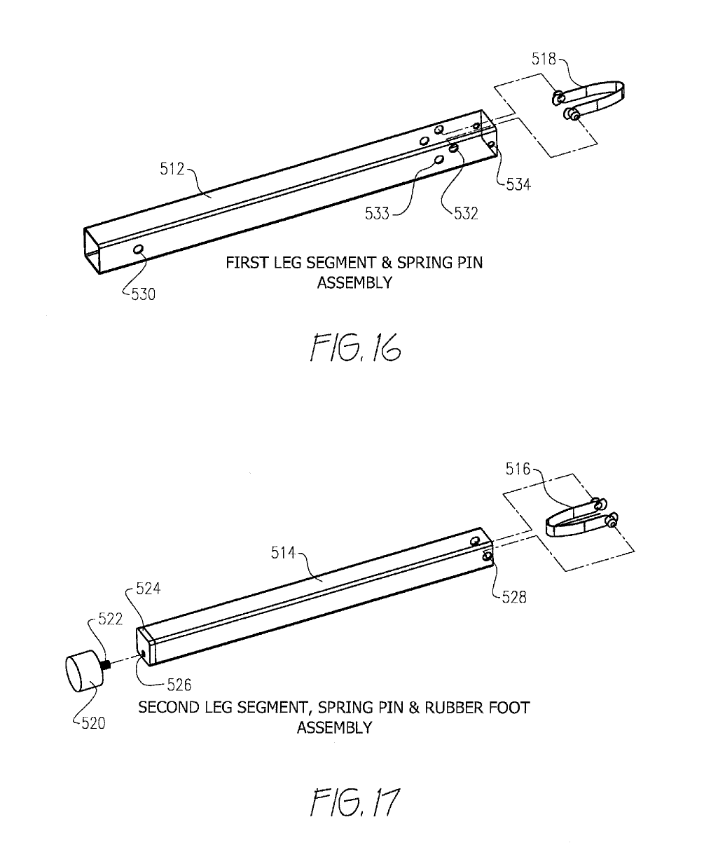

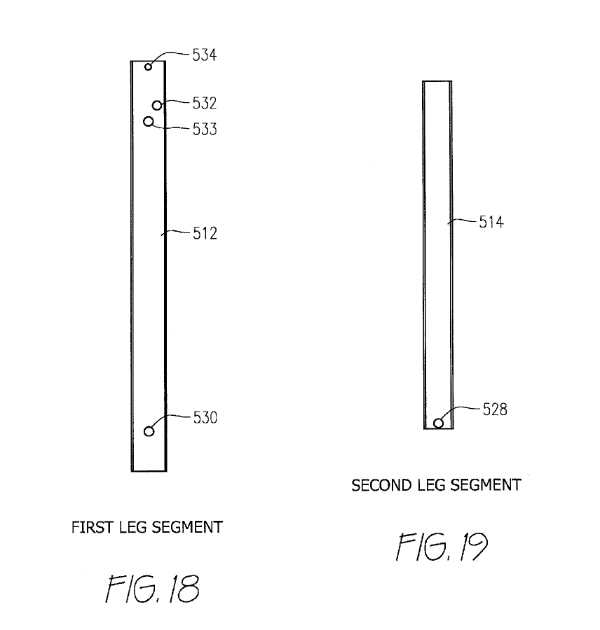

FIG. 16 is an exploded perspective view of the first leg segment and spring pin assembly shown in FIG. 6. FIG. 17 is an exploded perspective view of the second leg segment and spring pin and rubber foot assembly shown in FIG. 6. FIG. 18 is a plan view of the first leg segment shown in FIG. 16. FIG. 19 is a plan view of the second leg segment shown in FIG. 17.

Although features associated with a telescoping leg assembly 510 are described above with respect to FIG. 6, FIGS. 16-19 show a few additional details not previously described. The pins of double ended spring pin 518 are aligned with and engaged with through holes 532 in first leg segment 512. Spring pin 518 provides for releasably locking the leg at different angles with respect to the case by interaction with through holes 546 and 550 in the leg base flanges. The pins of double ended spring pin 516 are aligned with and are engaged with through holes 528 in second leg segment 514. Spring pin 516 provides for releasably locking the legs 510 in an extended or contracted configuration by interaction with through holes 530 and 533 in the first leg segment 512. In addition, FIG. 17 shows that second leg segment 514 is capped with end plate 524; end plate 524 includes a threaded through hole 526 that receives a threaded rod 522 of a stabilizing foot 520, thereby allowing the farthest end of telescoping leg assembly 510 to terminate in a stabilizing foot.

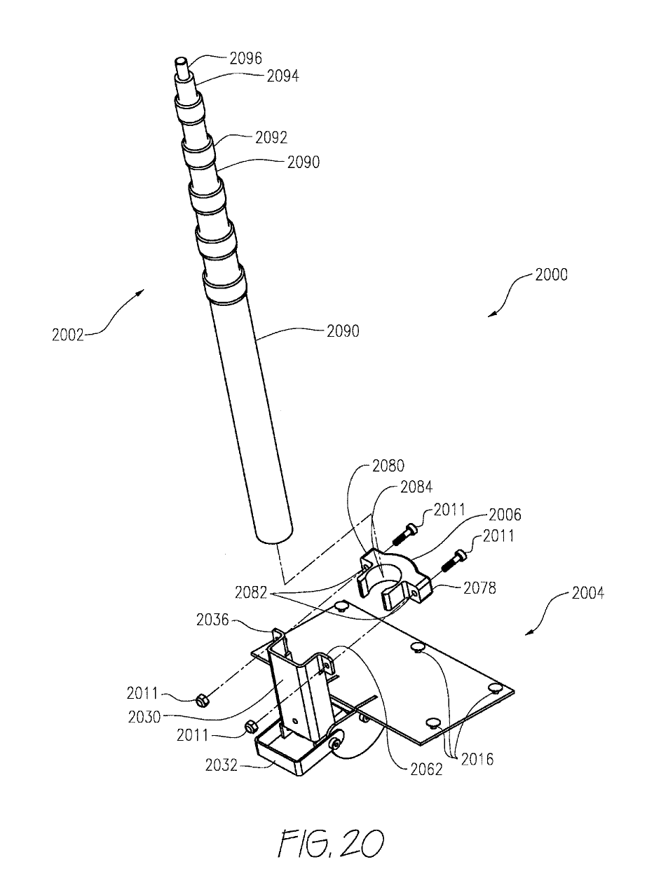

FIG. 20 is an exploded perspective view of the mast support assembly shown in FIG. 4. As shown in FIG. 20, mast support assembly 2000 includes a telescoping mast 2002, a mast pivot support assembly 2004, and a mast clamp 2006.

As shown in FIG. 20, telescoping mast 2002 includes multiple telescoping sections 2090. Each successive telescoping section 2090 in telescoping mast 2002 has a successively smaller outside diameter than a previous, or lower, telescoping section 2090 in telescoping mast 2002, thereby allowing the telescoping sections to be arranged in a telescoping configuration. Each telescoping section 2090 includes a gripping portion 2092 that may be tightened to securely grip a next telescoping section in telescoping mast 2002. A top telescoping section 2094 terminates in a junction rod 2096 which may be, for example, a solid threaded rod capable of receiving a threaded nut, or a tapped threaded rod capable of receiving a bolt. Junction rod 2096 is used to attach various functional devices and/or assemblies to the raised end of telescoping mast 2002, as described in greater detail below.

As further shown in FIG. 20, telescoping mast 2002 is attached, e.g., clamped, to a mast support bracket assembly 2030 of mast pivot support assembly 2004 by mast clamp 2006 and fasteners. For example, flange 2080 of mast clamp 2006 is secured to flange 2036 of mast support bracket assembly 2030 with a bolt 2011 via through hole 2038 and flange 2078 of mast clamp 2006 is secured to flange 2062 of mast support bracket assembly 2030 with a bolt 2011 via through hole 2038, thereby allowing telescoping mast 2002 to be securely held within a mast retaining bracket 2084 of mast clamp 2006.

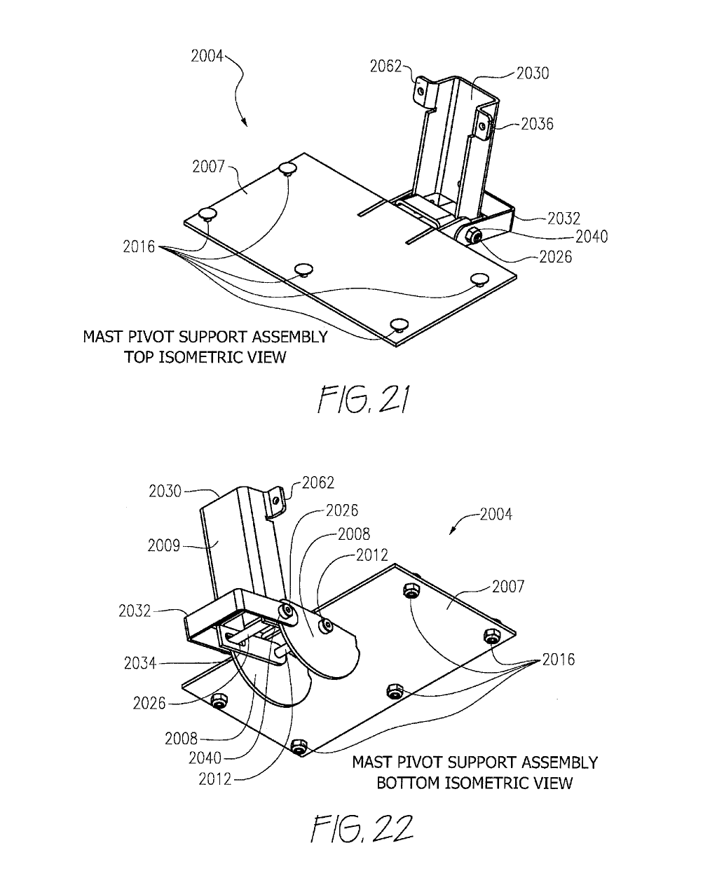

FIG. 21 is a top perspective view of a mast pivot support assembly of the telescoping support assembly shown in FIG. 20. FIG. 22 is a bottom perspective view of a mast pivot support assembly of the telescoping support assembly shown in FIG. 20. FIG. 21 and FIG. 22 show expanded images of parts of mast pivot support assembly 2004.

Referring to FIG. 21, mast pivot lock pull handle 2032 is held to mast support bracket assembly 2030 by position adjusting bolt 2026, which passes through round through holes 2040 in mast pivot lock pull handle 2032 and elongated through holes 2034 in mast support bracket assembly 2030. As shown in FIG. 22, mast support bracket assembly 2030 is adjustably attached to a pair of mast pivot guides 2008 with position adjusting bolt 2026 and pivot bolt 2012, as described in greater detail below.

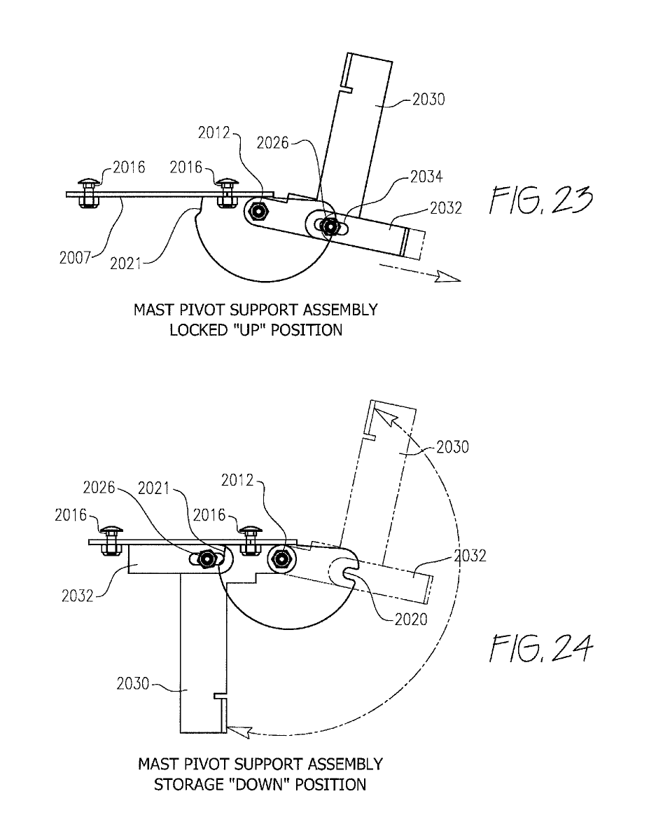

FIG. 23 is side view of the mast pivot support assembly 2004 of FIG. 20 in a locked “UP” position. FIG. 24 is side view of the mast pivot support assembly 2004 of FIG. 20 that has been repositioned from a locked “UP” position to a locked “DOWN” position. As shown in FIG. 23 and FIG. 24 mast support bracket assembly 2030 pivots about pivot bolt 2012. Pulling mast pivot lock pull handle 2032 in the direction of the arrow shown in FIG. 23, disengages position adjusting bolt 2026 from catch groove 2020 in mast pivot guide 2008, allowing mast pivot lock pull handle 2032 and mast support bracket assembly 2030 to pivot about pivot bolt 2012 until position adjusting bolt 2026 is aligned with and engages catch groove 2021 in mast pivot guide 2008. Although not shown, a tension spring 2022, between pivot bolt 2012 and position adjusting bolt 2026 is used to hold and bias position adjusting bolt 2026 within catch groove 2020 when mast pivot support assembly 2004 is locked in the “UP” position, and is used to hold position adjusting bolt 2026 within catch groove 2021 when mast pivot support assembly 2004 is locked in the “DOWN” position. To rotate mast pivot support assembly 2004 from a first locked position to a second locked position, mast pivot lock pull handle 2032 is pulled to overcome the tension on tension spring 2022, thereby dislodging position adjusting bolt 2026 from a first catch groove and allowing mast support bracket assembly 2030 and mast pivot lock pull handle 2032 to rotate about pivot bolt 2012 until adjusting bolt 2026 is aligned with and engages a second catch groove with tension supplied by tension spring 2022.

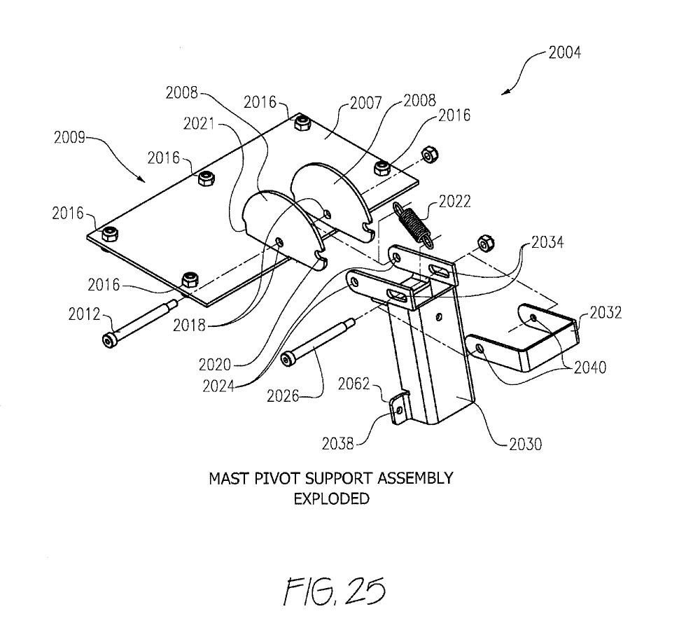

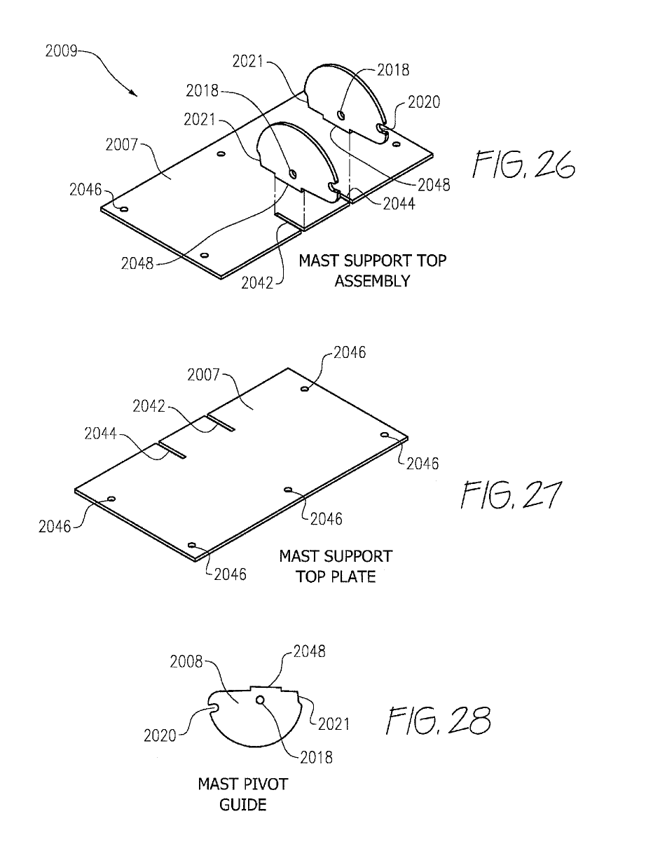

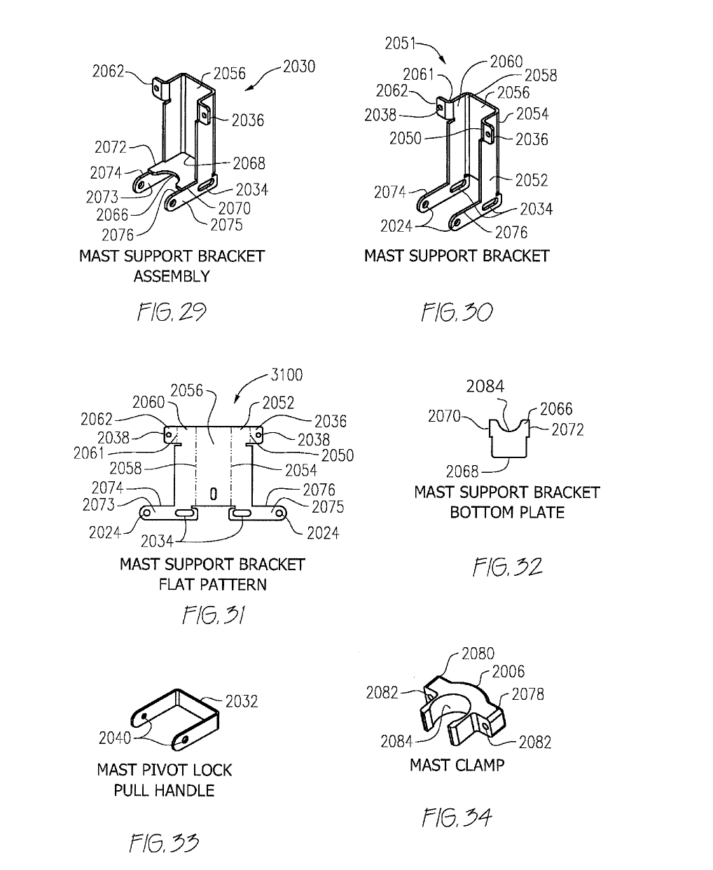

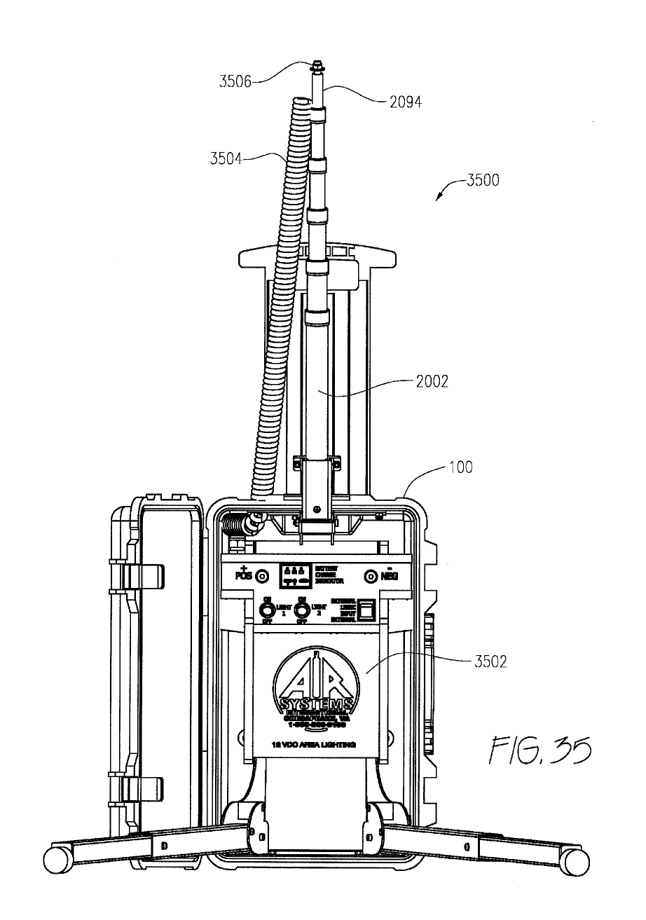

FIG. 25 is an exploded perspective view of the mast pivot support assembly of FIG. 20. As shown in FIG. 25, mast pivot support assembly 2004 includes a mast support top assembly 2009 and a mast support bracket assembly 2030. Through holes 2024 in mast support bracket assembly 2030 are aligned with through holes 2018 in mast support top assembly 2009 and pivot bolt 2012 is inserted through the aligned holes to connect mast support top assembly 2009 to mast support bracket assembly 2030.

Round through holes 2040 in mast pivot lock pull handle 2032 are aligned with elongated through holes 2034 in mast support bracket assembly 2030 and position adjusting bolt 2026 is inserted through the aligned holes to connect mast pivot lock pull handle 2032 to mast support bracket assembly 2030.

Tension spring 2022 is positioned between position pivot bolt 2012 and adjusting bolt 2026 with pivot bolt 2012 passing through a first looped end of tension spring 2022 and adjusting bolt 2026 passing through a second looped end of tension spring 2022. As described above, tension from tension spring 2022 is used to selectively engage adjusting bolt 2026 with one of catch groove 2020 and catch groove 2021 to lock mast support bracket assembly 2030 in one of an “UP” position and a “DOWN” position.

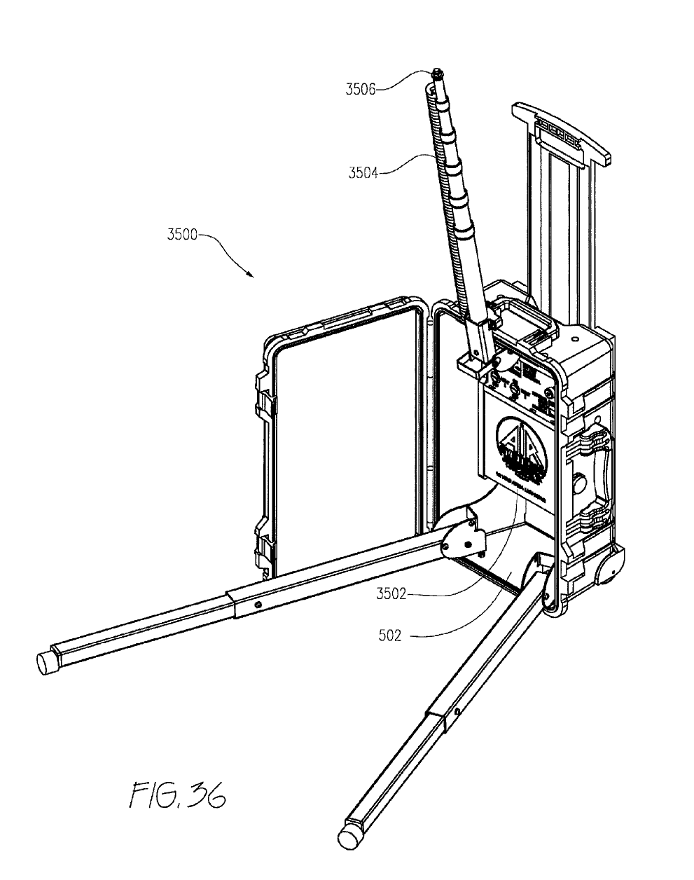

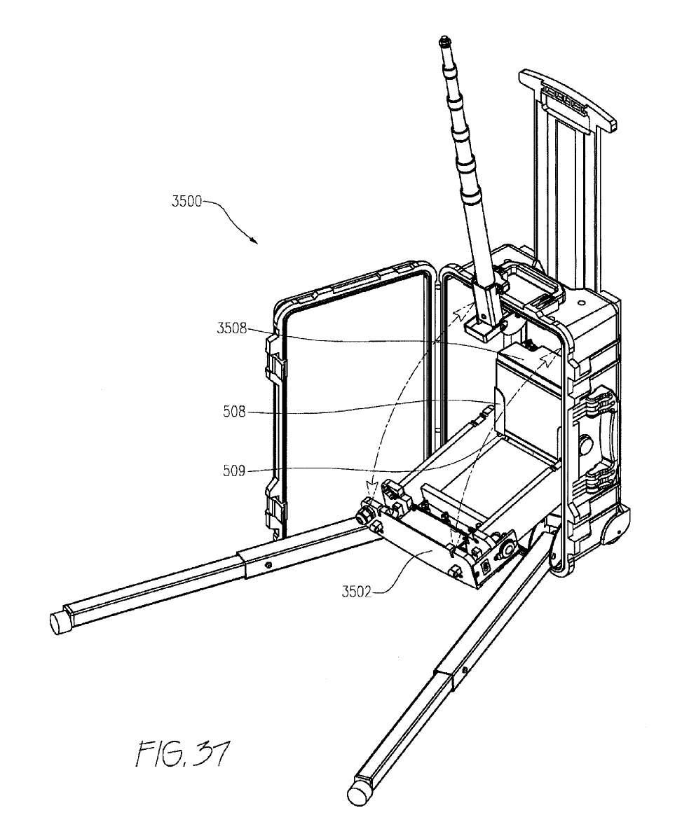

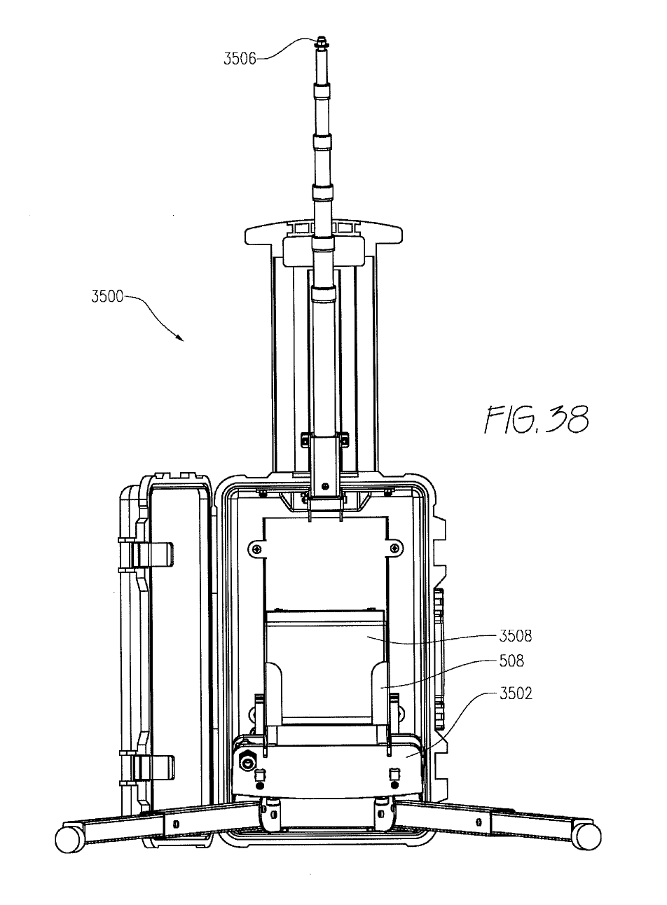

FIG. 26 is an exploded perspective view of the mast support top assembly 2009 shown in FIG. 25. FIG. 27 is a perspective view of the mast assembly mounting plate shown in FIG. 26. FIG. 28 is a plan view of a mast pivot guide 2008 shown in FIGS. 20 to 26.

As shown in FIG. 27, mast assembly mounting plate 2007 includes a first slot 2044, a second slot 2042 and multiple through holes 2046. As shown in FIG. 28, mast pivot guide 2008 includes catch groove 2020, catch groove 2021, tab 2048 and through hole 2018. As shown in FIG. 26, a first mast pivot guide 2008 is attached to mounting plate 2007 by securing tab 2048 of the mast pivot guide into slot 2042 of mounting plate 2007 such that catch groove 2020 is pointed away from mounting plate 2007, and a second mast pivot guide 2008 is attached to mounting plate 2007 by securing tab 2048 of the mast pivot guide into slot 2044 of mounting plate 2007 such that catch groove 2020 is pointed away from mounting plate 2007.

FIG. 29 is a perspective view of the mast support bracket assembly shown in FIG. 25. FIG. 30 is a perspective view of the mast support bracket shown in FIG. 29. FIG. 31 is a flat pattern for making the mast support bracket shown in FIG. 30. FIG. 32 is a plan view of the mast support bracket bottom plate shown in FIG. 29.

As shown in FIGS. 29 to 32, mast support bracket assembly 2030 includes a mast support bracket 2051 (FIG. 30) and a mast support bracket bottom plate 2066 (FIG. 32).

As shown in FIG. 31, mast support bracket 2051 may be fabricated from a sheet of material 3100 (e.g., metal) that has been cut, e.g., with a metal saw, metal cutting stamp or metal cutting laser, in the shape or pattern shown.

As shown in FIG. 31, a piece of materiel, e.g., sheet metal, cut in accordance with pattern 3100 includes a right upper flange 2062, a right side 2060 with protruding right lower flange 2073, a back side 2056, a left side 2052 with protruding left lower flange 2075 and a left upper flange 2036. Right lower flange 2073 and left lower flange 2075 each include a round through hole 2024 and an elongated through hole 2034. Right upper flange 2062 is separated from right side 2060 by a fold line 2061. Right side 2060 is separated from back side 2056 by a fold line 2058. Back side 2056 is separated from left side 2052 by a fold line 2054. Left upper flange 2036 is separated from left side 2052 by a fold line 2050.

As shown in FIG. 30 and FIG. 31, to form mast support bracket 2051 from a piece of sheet metal cut in accordance with pattern 3100, right side 2060 is folded along fold line 2058 ninety degrees towards back side 2056, right upper flange 2062 is folded along fold line 2061 ninety degrees away from back side 2056, left side 2052 is folded along fold line 2054 ninety degrees towards back side 2056 and left upper flange 2036 is folded along fold line 2050 ninety degrees away from back side 2056.

As shown in FIG. 29 and FIG. 32, a mast support bracket assembly 2030 is formed by securing a mast support bracket bottom plate 2066 on mast support bracket 2051 such that a back edge 2068 of mast support bracket bottom plate 2066 is in contact with back side 2056 of mast support bracket 2051, tab 2070 of mast support bracket bottom plate 2066 is in contact with an upper edge 2076 of lower flange 2075 of mast support bracket 2051, and tab 2072 of mast support bracket bottom plate 2066 is in contact with an upper edge 2074 of left lower flange 2073 of mast support bracket 2051.

FIG. 33 is a perspective view of a mast pivot lock pull handle, as shown in FIG. 25. As shown in FIG. 33, a mast pivot lock pull handle 2032 is formed of a rigid strap of sheet metal with two 90 degree bends. Through holes 2040 are formed in each end of mast pivot lock pull handle 2032 to allow attachment to mast support bracket assembly 2030, as described above.

FIG. 34 is a perspective view of the mast clamp shown in FIG. 20. As shown in FIG. 34, a mast clamp 2006 may be cast and/or milled from metal and includes flange 2078, flange 2080, through holes 2082 and mast retaining bracket 2084, that allow mast clamp 2006 to clamp telescoping mast 2002 to mast support bracket assembly 2030, as described above with respect to FIG. 20.

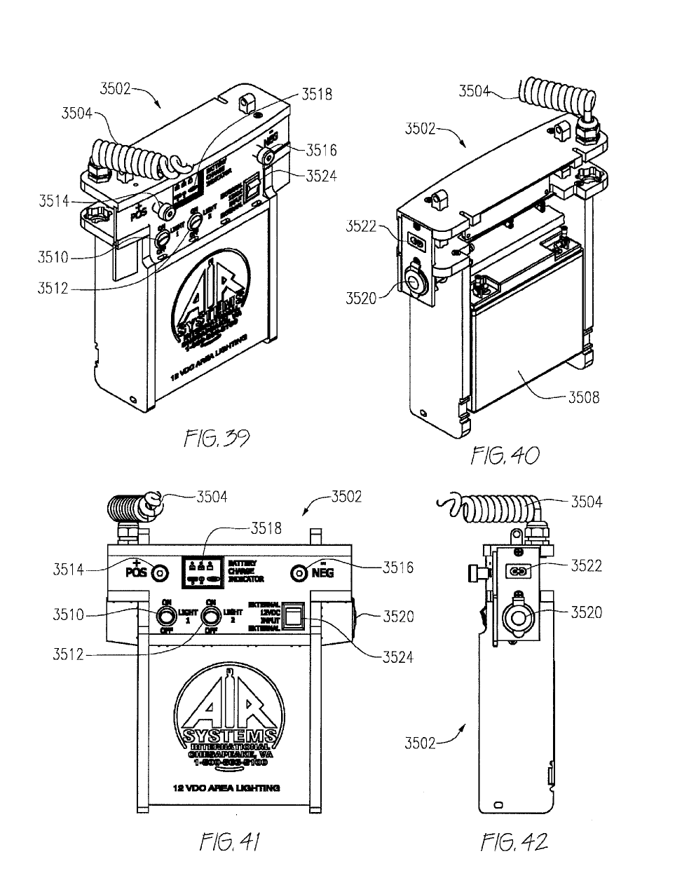

FIG. 35 is a front elevation view of a second exemplary embodiment of a collapsible portable stand with telescoping support and integral storage case in accordance with the present invention. As shown in FIG. 35, portable power control system 3500 includes collapsible portable stand 100, as described above with respect to FIG. 1, a power delivery controller 3502 and an extendable and retractable power/control cable 3504.

Power delivery controller 3502 may deliver electrical power and/or control signals via power/control cable 3504 to a functional device or devices mounted on the mast, e.g., electrical devices such as but not limited to lights, speakers, cameras, survey equipment (e.g., laser sight), podium, microphones, weapons, lasers, sensors, monitors, etc. Functional devices can be attached to the top telescoping section 2094 of telescoping mast 2002 via, for example, threaded accessory attachment bolt 3506.

It is noted that although power delivery controller 3502, shown in FIG. 35, is a 12-volt DC based system, embodiments of the present invention are not limited to use with a 12-volt DC based systems. For example, power delivery controller 3502 may be selected based on the electric power and conditioning requirements of electrical device(s) mounted on telescoping mast 2002.

FIG. 36 is a top-angled perspective front view of the collapsible portable stand shown in FIG. 35.

FIG. 37 is a top-angled perspective front view of the collapsible portable stand shown in FIG. 36 in which the power delivery controller 3502 is hinged at the base where power delivery controller 3502 is attached to inner mount case 508, thus forming a cover and retention device for the contents of inner mount case 508. As shown in FIG. 37, power delivery controller 3502 pivots from an up, or closed, position, to a down, or open position. Pivoting power delivery controller 3502 to an open position reveals a battery 3508 stored in, and held by, inner mount case 508. In an embodiment, power delivery controller 3502 is attached to inner mount case 508 via a pivot pin, not shown, which passes through a through hole in the case of power delivery controller 3502 and through hole 509 in inner mount case 508. In place of and/or in addition to a power source stored in case 508, other devices may be stored and/or connected thereto; for example, microprocessors and/or a computer with transmitting and/or receiver capabilities for remote control and monitoring may be included and/or connected to the case 200.

FIG. 38 is a front plan view of the collapsible portable stand shown in FIG. 37 in which the hinged cover for the inner mount case 508 has been placed in an open position showing a storage tray therein. The cover for inner mount case 508 may include securing bolts to remain closed whether or not the outer case door 202 is open, although case door 202 may be sufficient in many instances to secure closure of inner mount case 508 and/or to hold desired items in inner mount case 508 without having a separate cover therefore.

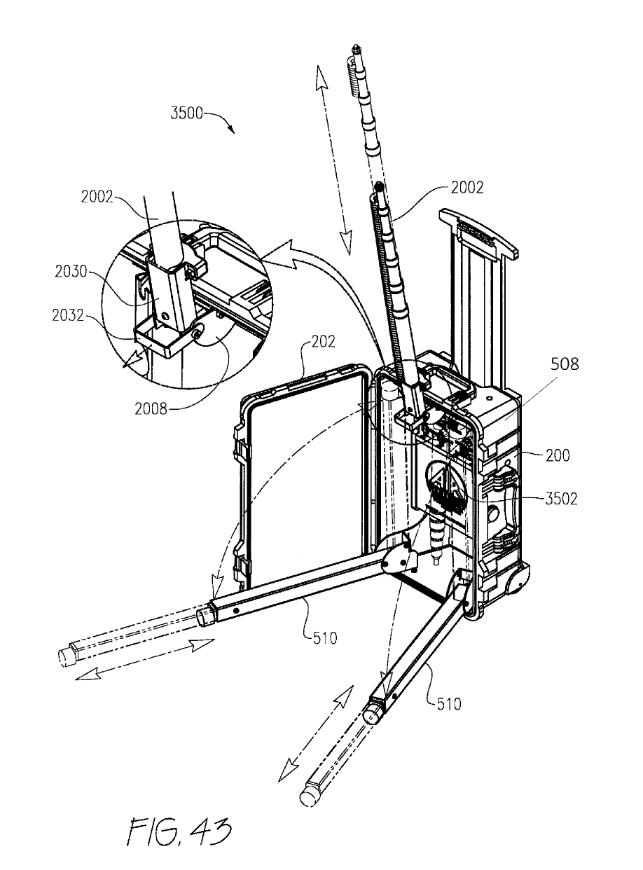

FIG. 39 is a top-angled perspective front view of the power supply controller embodiment 3502 shown in FIG. 35. FIG. 40 is a top-angled perspective rear view of controller 3502, while FIG. 41 is a front plan view and FIG. 42 is a side plan view thereof.

As shown in FIGS. 39-42, controller 3502 includes a first power control switch 3510, a second power control switch 3512, a positive terminal 3514, a negative terminal 3516, a status indicator 3518, a first power inlet/outlet 3520, a second power inlet 3522, and an internal/external power supply switch 3524. First power control switch 3510 may be used to control power to a first electrical device mounted on telescoping mast 2002. Second power control switch 3512 may be used to control power to a second electrical device mounted on telescoping mast 2002. Positive terminal 3514 and negative terminal 3516 can receive power from an external power source, e.g., via a set of cables, not shown. Status indicator 3518 may provide a status of battery 3508, if such a battery is provided, and internal/external power supply switch 3524 may be used to configure power delivery controller 3502 to deliver electrical power to electrical devices mounted on telescoping mast 2002 from battery 3508 or from an external power source, not shown. A battery in case 508 may be recharged via connections in the control panel. A solar panel for generating electricity may be incorporated into or onto the case and/or connected to the mast. Power outlet 3520 may be used to provide electrical power to ancillary equipment, e.g., communication equipment and/or computing devices. Should electromechanical actuators be used to manipulate the orientation (e.g., azimuth, rotation, height, precession about an axis, etc.) of functional devices, power sources can be shared via cables run through the center of the mast or via flexible, sealed pinch-free conduits with intrinsically safe fittings.

Hence, the present invention can provide a stable, self-contained platform that can be readily transported and set up and collapsed in remote locations for a variety of functional devices. With pivots and extensor hardware operable by tactile “touch, press and pull” action, the stand can be set up and collapsed in the dark. With intrinsically safe electric power and electric devices, systems can incorporate the platform for facile deployment and use in a variety of situations.

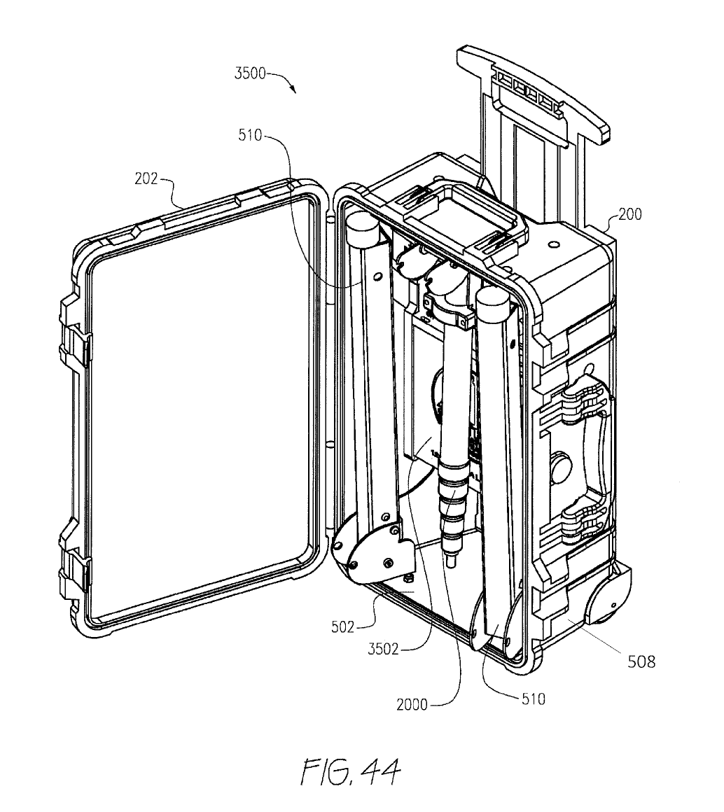

FIG. 43 is a top-angled perspective front view of the collapsible portable stand 3500 shown in FIG. 36, which demonstrates the degrees of freedom of motion for the leg assemblies and mast. FIG. 44 is a top-angled perspective front view of the collapsible portable stand shown in FIG. 43 in which the leg assemblies and mast have been contracted and folded into the integral storage case. As shown in FIG. 43 and FIG. 44, since the power delivery controller 3502 is confined within inner mount case 508, each leg assembly 510 and telescoping mast 2002 can be retracted and can be folded into interior space 224 of case 200, thereby allowing exterior door 202 to be secured, as described above with respect to FIG. 2 and FIG. 3.

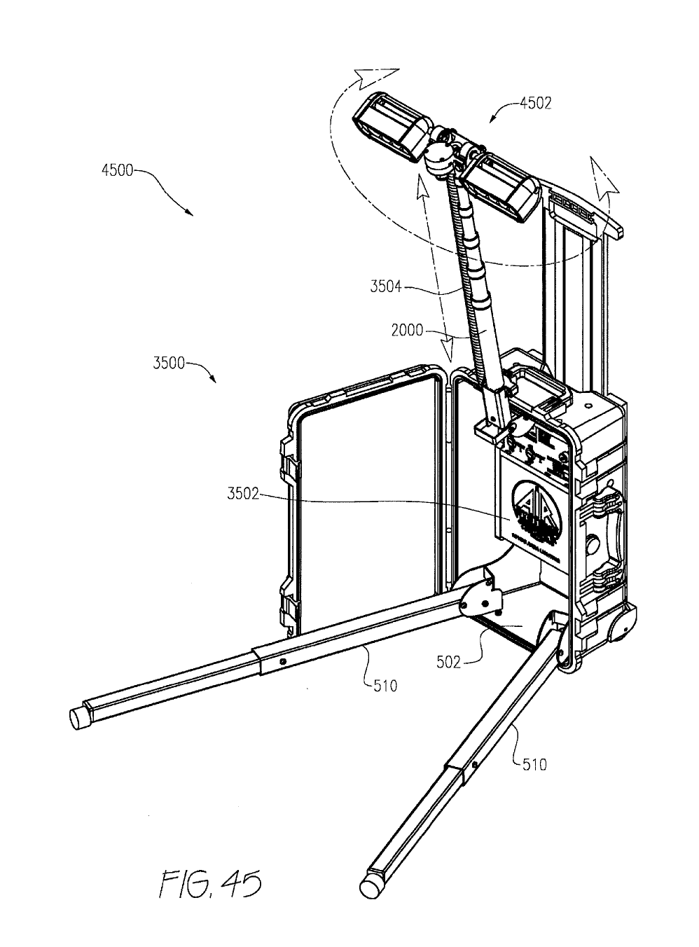

FIG. 45 is a top-angled perspective front view of a third exemplary embodiment of the present inventions. As shown in FIG. 45, portable lighting system 4500 includes collapsible portable stand 100, as described above with respect to FIG. 1, a power delivery controller 3502 and a power/control cable 3504, as described above with respect to FIGS. 35-44, and a lighting assembly 4502, that is attached an extended end of telescoping mast 2002 and electrically connected to power delivery controller 3502 via cable 3504. Lighting assembly 4502 is attached to top telescoping section 2094 of telescoping mast 2002 by a threaded accessory attachment bolt 3506.

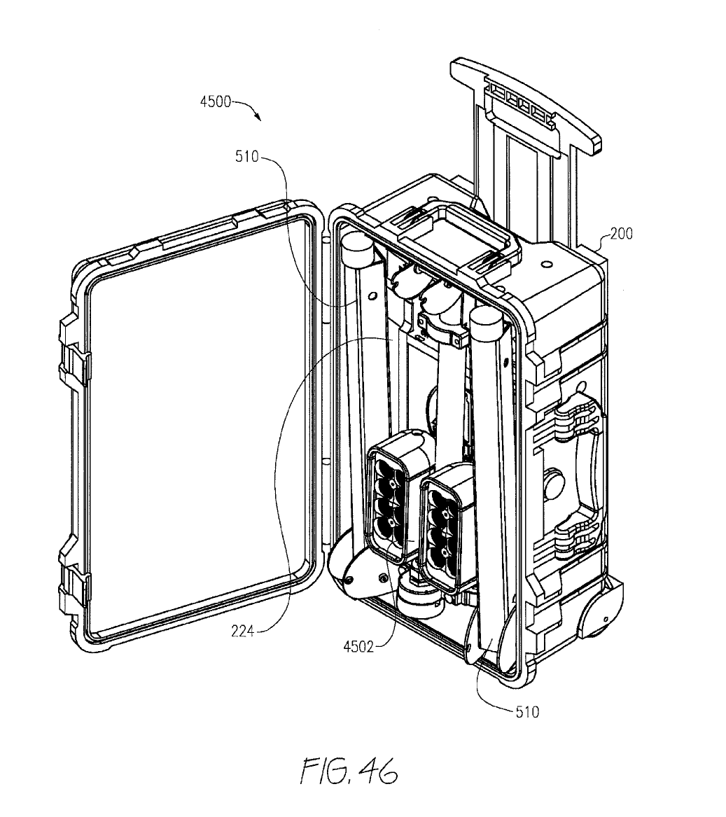

FIG. 46 is a top-angled perspective front view of collapsible portable stand 4500, described above with respect to FIG. 45 in which each leg assembly 510, telescoping mast 2002 and lighting assembly 4502 have been contracted and folded into interior space 224 of integral case 200.

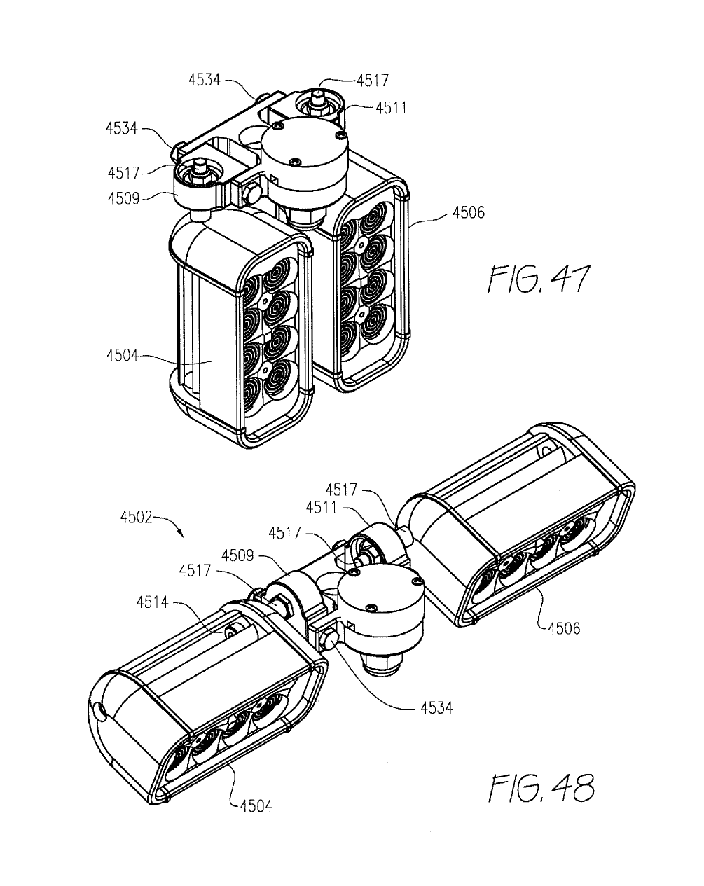

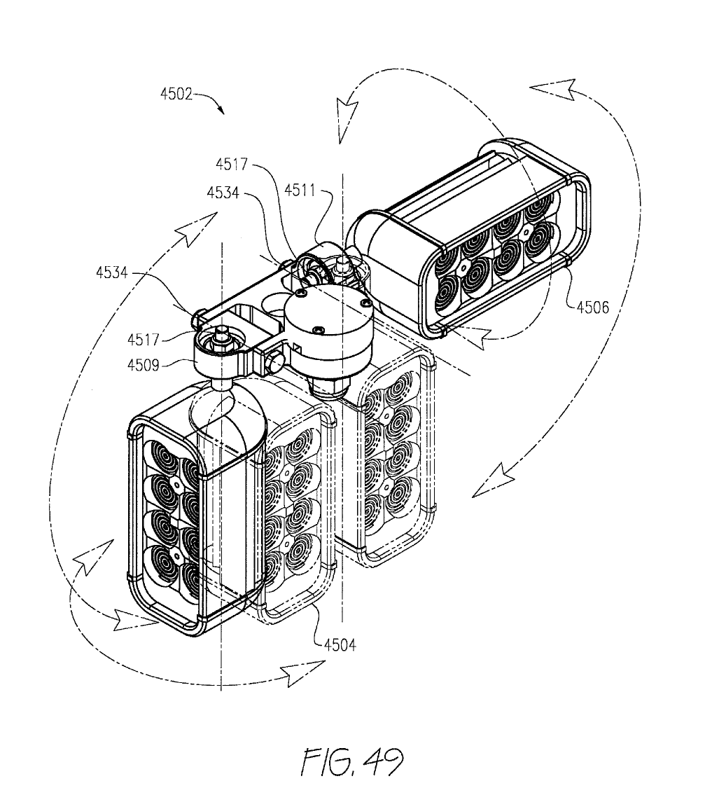

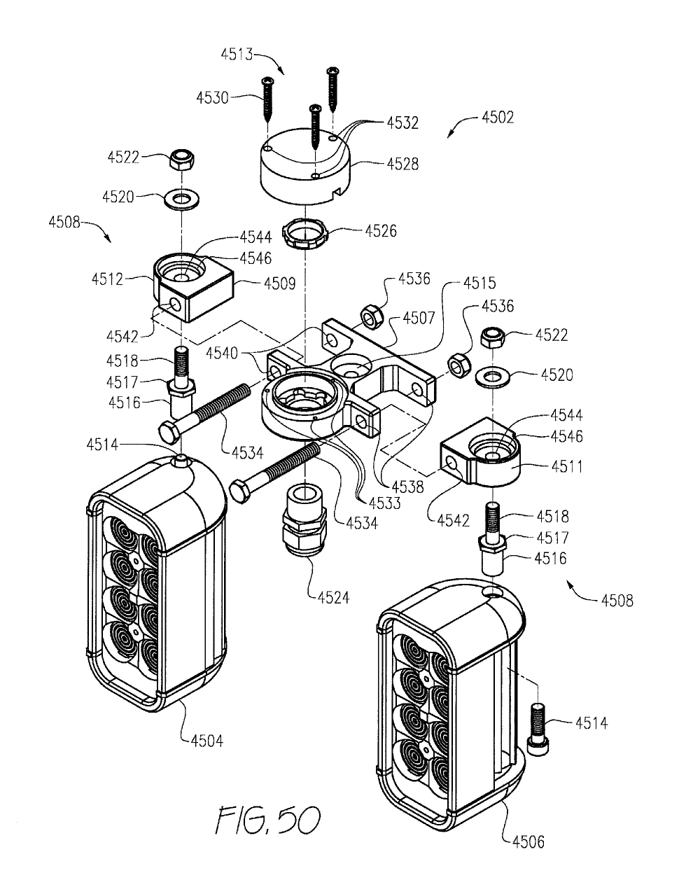

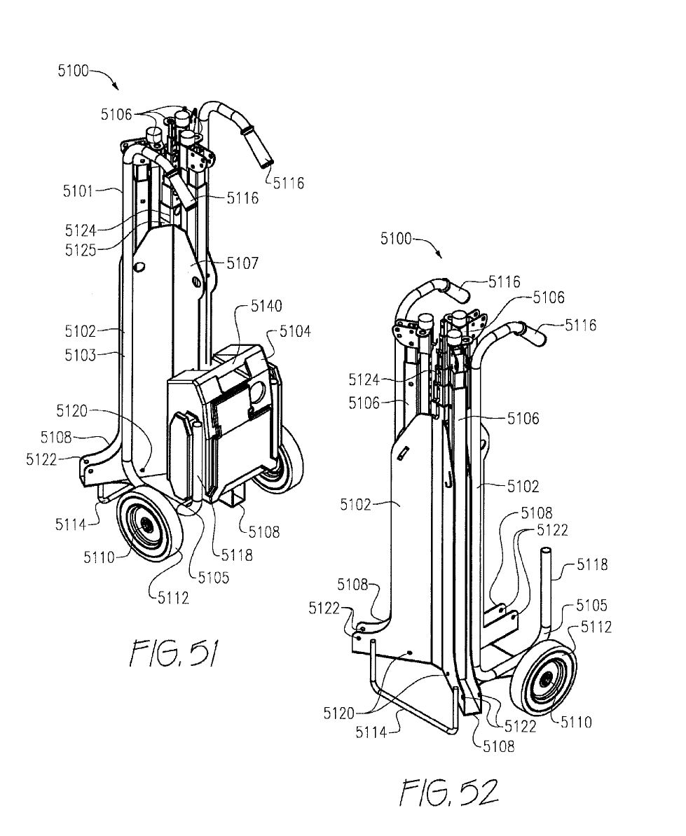

FIG. 47 is a top-angled perspective front view of lighting assembly 4502 of FIG. 46 in a folded configuration. FIG. 48 is a top-angled perspective front view of lighting assembly 4502 in an open/expanded configuration. FIG. 49 is a top-angled perspective front view of lighting assembly 4502 in which the degrees of freedom of motion are demonstrated in changing the configuration of the lighting system from the folded configuration of FIG. 47 to the open/expanded configuration of FIG. 48. FIG. 50 is an exploded top-angled perspective front view of lighting assembly 4502.

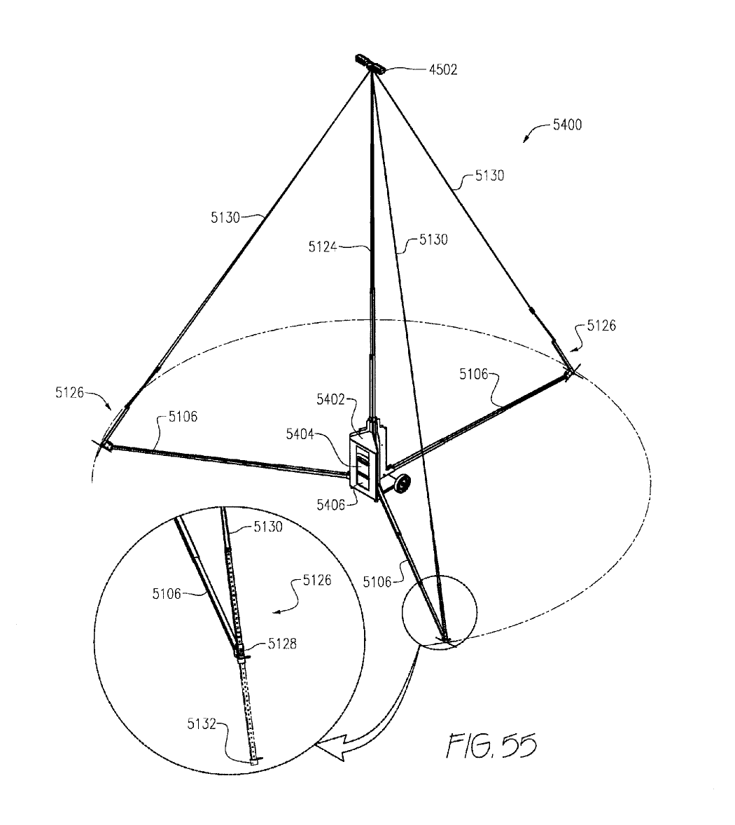

As shown in FIG. 50, a new mast mounting fixture 4507 is shown that can be rotatably mounted onto a mast (or other structure) via mast attachment fitting 4515. Lighting assembly 4502 incorporates mast mounting fixture 4507, and includes a first electrical light 4504, a second electrical light 4506 and assembly yoke 4508. Assembly yoke 4508 includes a first pivot mount 4509, a second pivot mount 4511, and an integrated electrical box 4513. Pivot mounts 4509 and 4511 are each directly attached to a rotatable connector for a light fitting, so that each light or other functional attachment connected to a pivot mount can rotate with respect its mount, e.g., 4509, and pivot up and down with respect to its mount. Hence both lights in FIG. 50 can rotate independently of each other in their respective pivot mounts, as well as be independently pivoted up and down in their respective mounts. In addition, the entire mast mounting fixture 4507 with the functional attachments connected thereto can be rotated about the mast. This creates multiple degrees of freedom of motion for each functional attachment. Further, since the height of the mast can be adjusted, an additional degree of freedom of motion for adjusting functional attachments to the mast is provided. In an embodiment, mast attachment fitting 4515 permits an optional mast extension to be mounted thereto, and the extension may be rotatably mounted in fitting 4515. By connecting one or more functional attachments to a second mounting fixture that provides for multiple degrees of freedom of motion for attachments, such as mounting fixture 4507, it is possible to have multiple and different functional attachments for which their direction can be independently adjusted. Mast mounting fixture 4507 may have more than two pivot mounts (e.g., such as 4509 and 4511), and include such extra mechanisms as may be needed to control functional attachments mounted thereon, as well as to incorporate and/or cooperate with electromechanical systems for remotely adjusting the direction (and optionally operation) of the functional attachment in each pivot mount. Multiple mast extensions may be utilized and electromechanically operated and/or monitored and controlled to create a multifunctional portable platform that can be remotely controlled. It is envisioned that one or more additional masts may be pivotally or otherwise mounted in or on the case. For extra stability, the legs may include means for attachment to a surface and/or the masts may be connected to the legs (e.g., see stabilizers in embodiments illustrated in FIGS. 53 and 55).

As further shown in FIG. 50, first light 4504 is connected to first pivot mount 4509 with a lower threaded bolt 4514, a rotating threaded coupler 4517, a washer 4520 and a nut 4522. Lower threaded bolt 4514 is passed through a casing of light 4504 and threaded into a threaded female end 4516 of rotating threaded coupler 4517. A threaded male end 4518 of rotating threaded coupler 4517 is passed through a through hole 4544 in a socket 4546 in first pivot mount 4509 and secured with washer 4520 and nut 4522. First pivot mount 4509 is mounted to lighting assembly yoke 4508 by aligning a through hole 4542 in first pivot mount 4509 with a through hole 4540 in lighting assembly yoke 4508, passing a bolt 4534 through the aligned holes and securing bolt 4534 with a nut 4536.

Similarly, as shown in FIG. 50, second light 4506 is connected to second pivot mount 4511 with a lower threaded bolt 4514, a rotating threaded coupler 4517, a washer 4520 and a nut 4522. Lower threaded bolt 4514 is passed through a casing of light 4506 and threaded into a threaded female end 4516 of rotating threaded coupler 4517. A threaded male end 4518 of rotating threaded coupler 4517 is passed through a through hole 4544 in a socket 4546 in second pivot mount 4511 and secured with washer 4520 and nut 4522. Second pivot mount 4511 is mounted to lighting assembly yoke 4508 by aligning a through hole 4542 in second pivot mount 4511 with a through hole 4538 in lighting assembly yoke 4508, passing a bolt 4534 through the aligned holes and securing bolt 4534 with a nut 4536.

In an embodiment, optional integrated electrical box 4513 receives at an open bottom face a threaded end of an electrical cable connector 4524, which is secured to an underside face of integrated electrical box 4513 with a threaded washer 4526 that is tightened on threads of electrical cable connector 4524 projected into an interior space of integrated electrical box 4513. Further, integrated electrical box 4513 receives at an open top face, an electrical box cover 4528 that is secured to the open top face with screws 4530 via holes 4532 in electrical box cover 4528 aligned with holes 4533 in the top face of integrated electrical box 4513.

As shown in FIG. 49, light 4504 pivots in a first direction within a socket 4546 of first pivot mount 4509 about an axis of rotating threaded coupler 4517, and light 4504 and first pivot mount 4509 pivot in a second direction, that is perpendicular to the first direction, about an axis of bolt 4534. Further, as shown in FIG. 49, light 4506 pivots in a first direction within a socket 4546 of second pivot mount 4511 about an axis of rotating threaded coupler 4517, and light 4506 and second pivot mount 4511 pivot in a second direction, that is perpendicular to the first direction, about an axis of bolt 4534. In addition, although not shown in FIG. 49, lighting assembly 4502 pivots in a third direction, that is perpendicular to both the first direction and the second direction, about an axis of telescoping mast 5124. By allowing light 4504 and light 4506 to each independently rotate on a different axis, lighting assembly 4502 may be configured to shine light in virtually any direction relative to a fixed position of telescoping mast 5124.

A suitable light for use in for example the embodiments shown in FIGS. 45-50 is available from Vision X Global Lighting Systems of Seattle, Wash., USA (“VISIONX”). For example, LED lights, such as but not limited to those available from VISIONX, are energy efficient and provide a bright stable light output. LEDs can be used to generate output at frequencies suitable for supporting night vision (e.g., for a platform/stand for monitoring in dark or low light situations, such as for border enforcement or guarding defensive perimeters). Suitable cases that can be modified to construct embodiments of the present invention, such as by modification to include extendable and collapsible legs, a mast, etc., are available from Pelican Products of Torrance, Calif. USA (e.g., models 1510 and 1560).

FIG. 51 is a top-angled front perspective view of a fourth exemplary embodiment of a collapsible portable stand with telescoping support. As shown in FIG. 51, a fourth embodiment of a collapsible portable stand with telescoping support 5100 includes, a two-wheeled cart 5101, a leg assembly unit 5107, a telescoping mast 5124, and a portable power supply 5104. The embodiment shown is useful for meeting the need for a stable portable platform for functional devices mounted and/or used at heights in excess of 15 feet or more than 20 feet. Ideally, the footprint of the unit when the mast is fully extended has a diameter about equal to the mast height, but the footprint can vary widely depending on the need and on the ability to anchor the legs to a surface.

Leg assembly unit 5107 includes three leg assembly supports, each leg assembly support 5108 configured with a leg assembly 5106 pivotally attached to a base of the leg assembly support at pivot through-pin 5120. Leg assembly unit 5107 includes a center space 5125 at the center of leg assembly unit 5107 that holds and retains telescoping mast 5124.

Two-wheeled cart 5101 includes a pair of main structural supports, each structural support 5102 includes a handle portion 5116, a vertical body portion 5103, a horizontal base portion 5105 and a lower vertical restraint portion 5118. A horizontal base portion 5105 of each structural support 5102 proximate to lower vertical restraint portion 5118 is connected, e.g., welded, bolted, etc., adjacent to each end of an axel 5110. A wheel 5112 is connected to each end of axel 5110. Leg assembly unit 5107 is affixed to the vertical body portions 5103 of two-wheeled cart 5101, thereby rigidly holding each respective vertical body portions of two-wheeled cart 5101 in the same vertical plane and parallel to each other. For example, in FIG. 51, leg assembly support 5108 is positioned to allow the respective leg assemblies to be pivotally lowered and to extend at 120° angles from a center point of cart 5101 the wheel. A double ended spring pin 518, as described above with respect to FIG. 5 and FIG. 6, is allowed to engage through holes 5122 to hold each lowered respective leg assembly in the lowered position, as described above.

As further shown in FIG. 51, a portable power supply 5104 with a handle 5140 is held in a position above axel 5110 and between the two wheels by lower vertical restraint portion 5118. Portable power supply 5104 may be temporarily removed from the cart 5101, if necessary, to allow one or more leg assemblies stored in leg assembly unit 5107 to be lowered, and may be replaced on the cart once the one or more leg assemblies have been lowered.

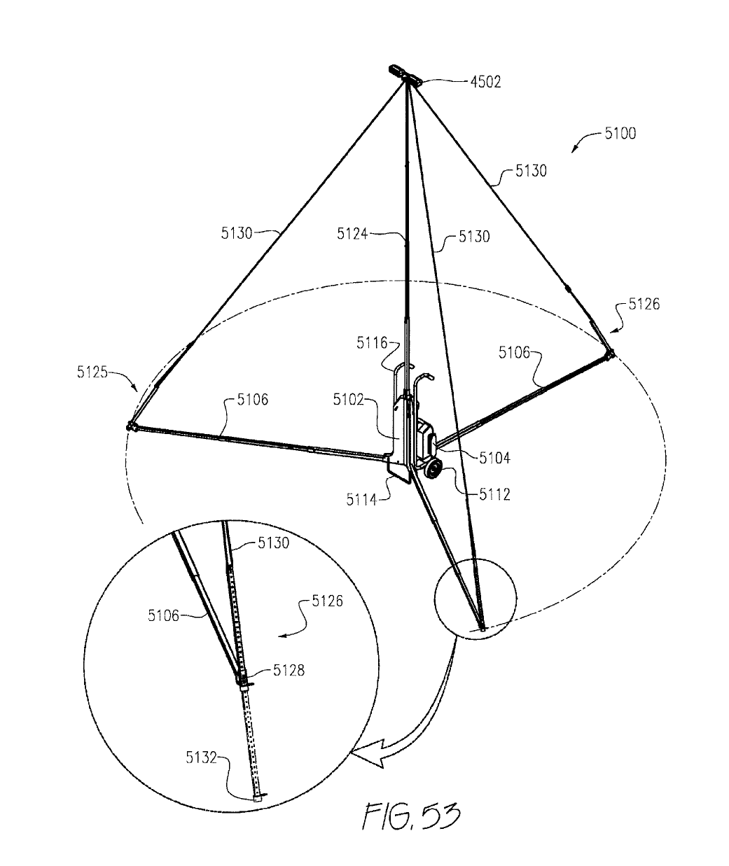

FIG. 52 is a top-angled rear perspective view of the collapsible portable stand with telescoping support shown in FIG. 51. In FIG. 52, cart 5101 is shown with portable power supply 5104 removed. Further, a support stand 5114 is shown attached to leg assembly unit 5107 so that cart 5101 stands perpendicular to a support surface, e.g., the ground or a floor. In one embodiment, support stand 5114 is adjustable to different heights to accommodate a support surface that is not level.

FIG. 53 is a top-angled rear perspective view of collapsible portable stand 5100. As shown in FIG. 53, collapsible portable stand 5100 has been configured with a lighting assembly 4502 mounted on the extended telescoping support. The leg assemblies and telescoping support are fully extended.

As further shown in FIG. 53, the end leg segment of each leg assembly 5106 includes a leveling arm 5126. Leveling arm 5126 includes an adjustable clasp 5128 that is pivotally connected to an end of the leg assembly and allows a length of leveling arm 5126 that extends below clasp 5128 to be adjusted. A lower end of leveling arm 5126 terminates with a foot 5132 and opposite end of leveling arm 5126 attaches to a tension line 5130 that extends from leveling arm 5126 to a top section of the telescoping mast 5124. The length of tension line 5130 may be adjusted to provide even tension between the top of telescoping mast 5124 and each leveling arm 5126, thereby allowing telescoping mast 5124 to be held vertical and stable.

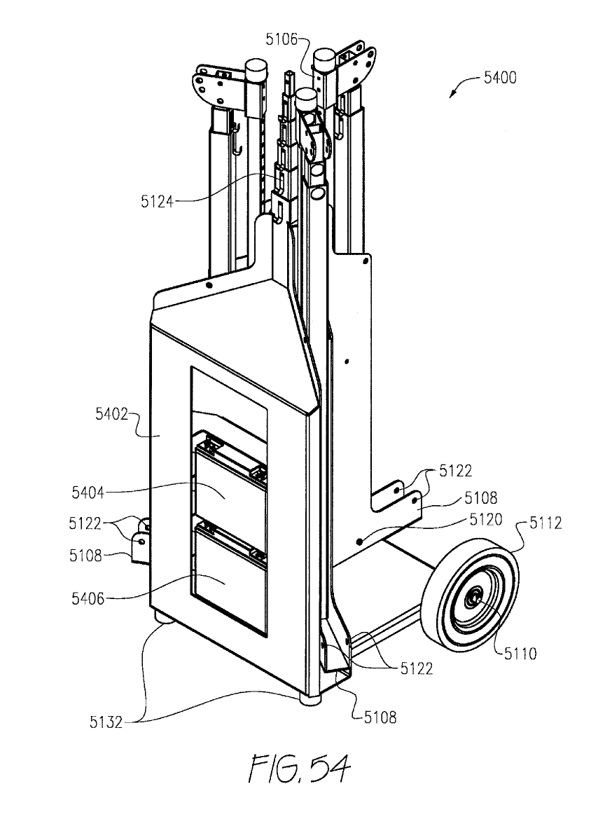

FIG. 54 is a top-angled perspective view of a fifth exemplary embodiment of a collapsible portable stand with telescoping support. As shown in FIG. 54, collapsible portable stand 5400 is very similar to the collapsible portable stand 5100 described above with respect to FIGS. 51-53. Like feature in FIG. 54 have been assigned like labels and will not be again described.

As shown in FIG. 54, collapsible portable stand 5400 includes a fixed power supply 5402, that replaces portable power supply 5104 and support stand 5114 of collapsible portable stand 5100. In the embodiment shown in FIG. 54, fixed power supply 5402 includes a first power source 5404, e.g., a battery or capacitor, and a second power source 5406.

FIG. 55 is a top-angled rear perspective view of collapsible portable stand 5400 with telescoping support. As shown in FIG. 55, collapsible portable stand 5400 has been configured with a lighting assembly 4502 mounted on the extended telescoping support. The leg assemblies and telescoping support have been fully extended.

As shown in FIG. 55, collapsible portable stand 5400 is configured for use in a manner very similar to collapsible portable stand 5100 described above with respect to FIG. 53. Like features in FIG. 55 have been assigned like labels and, therefore, are not again described.

Functional devices mounted to yoke 4508 described above with respect to FIGS. 47-50 are not limited to lights but include any electrical or non-electrical device including, but not limited to a light; a microphone; a camera; a loudspeaker; a weather monitoring device; a solar panel; and a motion sensing device, and other functional devices mentioned earlier.

An extendible leg assembly, as described above, is not limited to the use of leg segments arranged in a telescoping configuration, but that an extendible leg assembly may use folding leg segment and/or a combination of folding and telescoping leg segments.

References to attaching, securing, or fastening one component to another may be accomplished by any known technique appropriate within the context of the components being joined which includes, but is not limited to, the use of one or more bolts, screws, adhesive, metal welds, metal crimps, and any other form or attaching one component to another.

Case 200 described above may be equipped with tamper-proof features, particularly for government, military, border control, police and for other uses requiring enhanced security.

The dimensions and volumes of case 200 may be adjusted to meet specific needs. In one exemplary embodiment, the stand legs are 32 inches long, an aluminium mast can be extended to 8 feet in height, and the case is 8′ deep, 22″ in height, and 14″ in width. The stand with a light fixture attached can withstand substantial winds without tipping. In a preferred embodiment, the case has sufficient volume to store dual LED lamp heads. Preferably, a battery or power supply is included inside the case, thus increasing the stability of the stand, while also making a more compact and useful deployable stand for lighting and other uses. Preferably, the mast can be extended to heights of at least 15 feet and preferably more than 20 feet above the surface on which a stand of the present inventions is mounted, so that a functional attachment on the top of the mast can be sufficiently stable to be utilized at such heights. It is envisioned that a self-leveling laser level (or levels) may be mounted to the mast, such as those used by masons, with corresponding electromechanical components incorporated into the stand and/or cart embodiment.

The case may be made intrinsically safe for use for example in volatile atmospheres. This can be accomplished by use of suitable fittings, contacts, switches, etc. that are gas tight and dustproof, and low currents, solid state relays, etc.

In another embodiment, the case can include at least one seal and/or is waterproof. While lights are used in some examples herein, one or more of the new mounting fixture of the present invention may be used for mounting plural items such as microphones, in addition to or in place of the light fixtures. For example, an embodiment of the present inventions could be used in a remote location to mount a video camera or cameras, a microphone, a still camera or video camera to lock in for example the identify of persons passing through the location and/or vehicles at an intersection. Border control, law enforcement and/or military uses include monitoring of persons, animals and/or equipment passing through remote or dangerous locations in inhospitable areas, and may include defensive or offensive capabilities, ranging from tasing (i.e., electrical discharge) to lethal action as dictated by circumstances either automatically controlled with systems onboard or remotely controlled with human interaction. A check point could be remotely monitored, with a mechanical arm for gathering documents or “sniffing” persons and vehicles to detect weapons or drugs. Further, a plurality of the fixtures could be mounted in between extensions of the telescoping mast so that the mast may have multiple stages with different attachments, lights, cameras, GPS (i.e., global positioning system), microphones, gas monitors, alarms, output screen and/or printer, etc., which can be vertically spaced from each other, and each functional attachment will have multiple degrees of freedom of adjustment to optimize use of the mobile platform. In an embodiment a microprocessor and transceiver can be operatively connected to the mast to remotely monitor and control the apparatus, as well as store and process information. In an optional embodiment, small electromechanical adjusters can be included in the mast and/or in the multiple degrees of freedom hinges using large, small or micro-electromechanical actuators as is known to one of ordinary skill in the art. Thus, the functional attachments to the mast, as well as mast height can be remotely controlled and monitored.

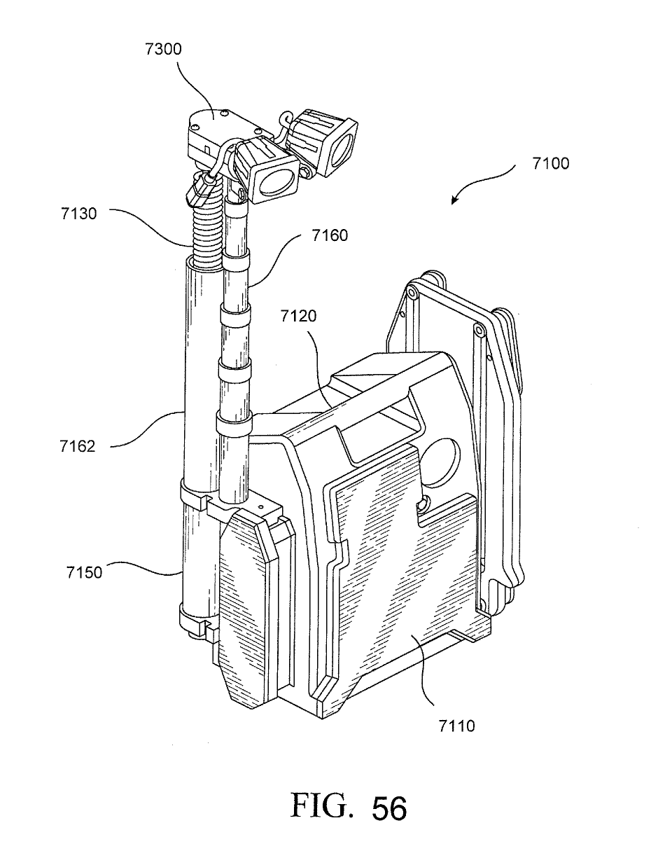

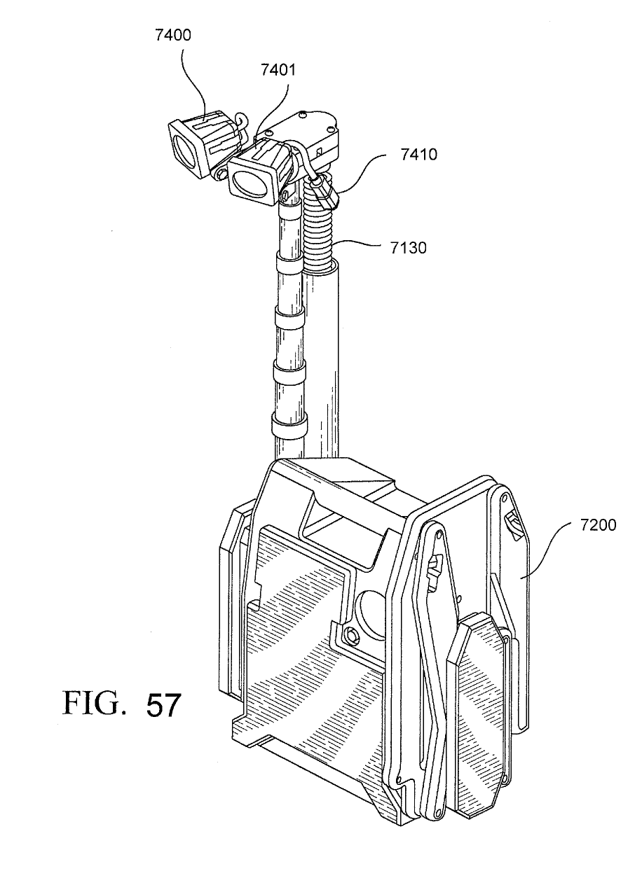

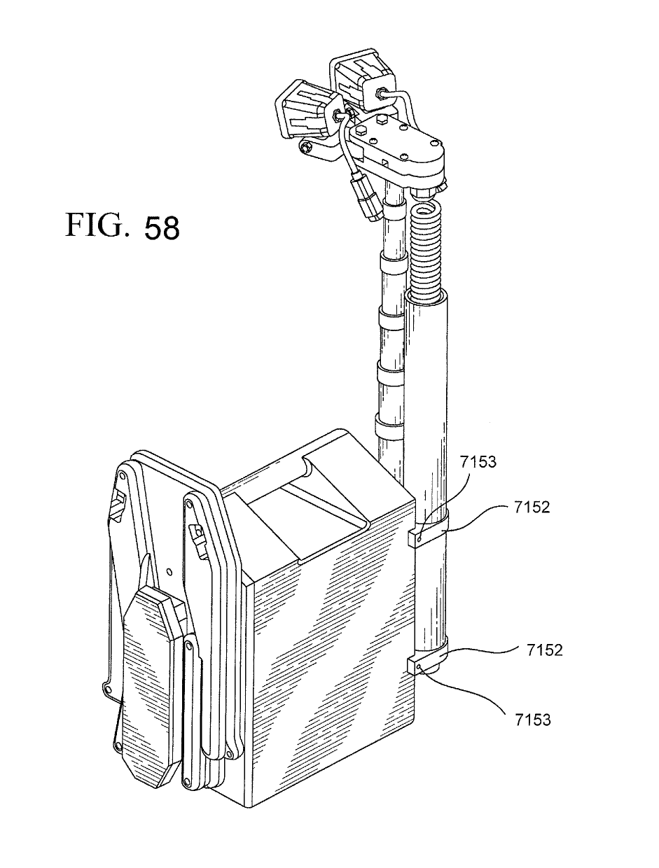

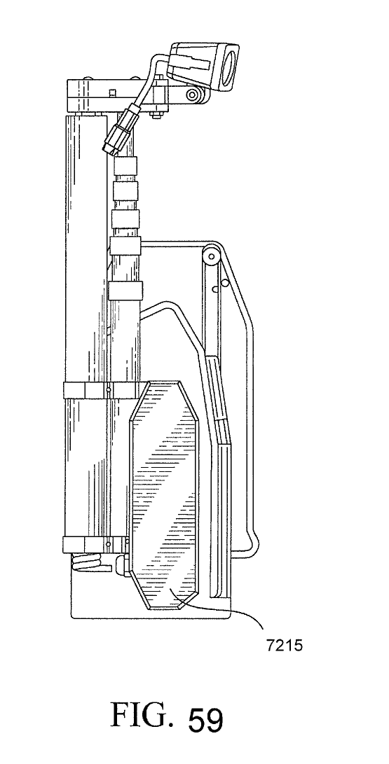

Referring to FIGS. 56 to 66, a further non-limiting embodiment of a stand 7100 in accordance with the present invention is illustrated. A main housing 7110 preferably contains a power supply and control panel. Access plugs for recharging and/or connecting the stand to a power supply are provided. In a preferred embodiment, a rechargeable battery is contained within the housing. In an embodiment, a 12 volt power port is provided on the main housing. The battery is preferably connected to a battery fitting to maintain it securely fixed in the housing and free from the environment. Preferably, the battery or other power supply is connected to electrical connections within the housing, and at least one power cord leads from the interior of the main housing through a sealed port to provide an external source of power for functional devices from the internal power supply.

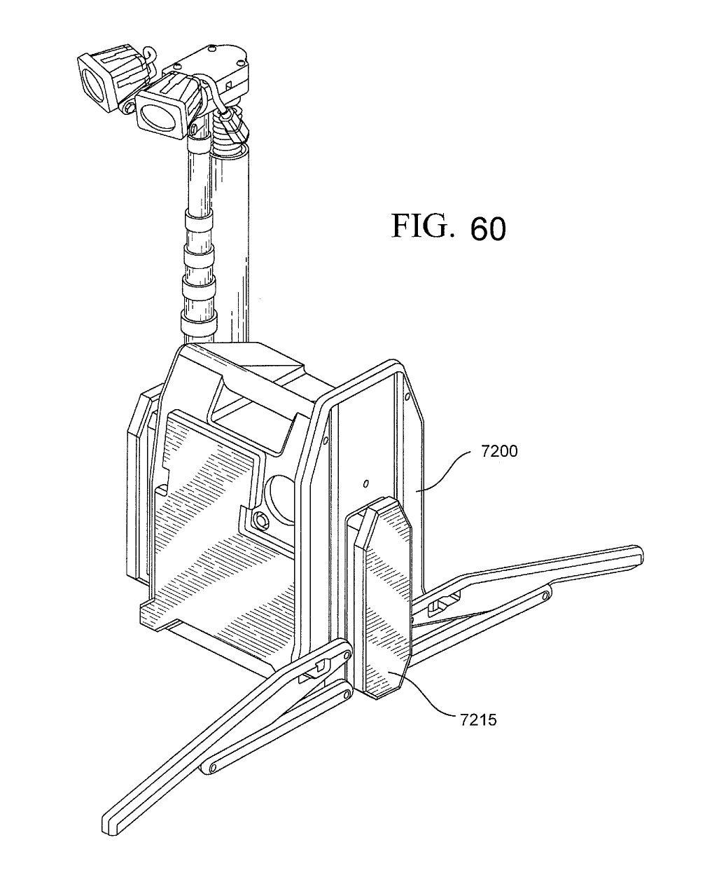

Main housing 7110 is preferably formed of a robust and durable plastic material, and includes a grip 7120 for ease of carrying. A power cord 7130 provides power for functional attachments that can be connected to a mast assembly 7150. A leg assembly 7200 is also provided on the main housing to provide stability for the stand 7100. In FIGS. 56 to 59, leg assembly 7200 is retracted, which is a preferred configuration for transport and storage. As shown in FIG. 60, the leg assembly can be extended to increase stability for the stand. The leg assembly 7200 is engaged with a cord wrap projection 7215 on the housing in FIGS. 56 to 60. While the embodiment shown in the FIGS. 56 to 66 uses a preexisting commercially available housing for a power supply that includes power cord wrap projections 7215 on opposite sides of the main housing 7110, the leg assembly can be attached to the stand other than as shown. An exemplary housing and power supply can be obtained from Clore Automotive of Lenexa, Kans., U.S.A., for example a Jump-N-Carry model JNC950 or JNC660.

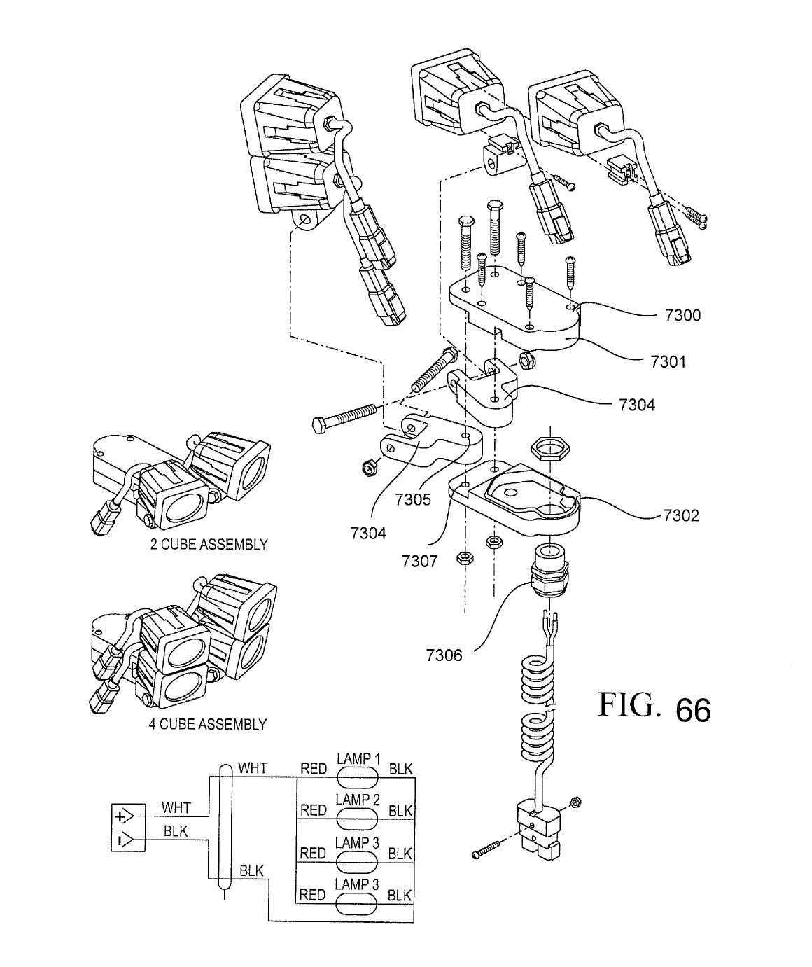

Extendable mast assembly 7150 is mounted near to and/or engaged with a second cord wrap projection on the main housing. The second cord wrap projection may be eliminated in other embodiments and the mast assembly may project upwards from the main housing 7110 from a suitable integral cavity formed therein. One or more brackets 7152 are used to mount the telescoping assembly to the housing via mounting holes 7153. The mast assembly 7150 includes an extendable mast 7160 and a cord protection sleeve 7162, both of which are engaged by brackets 7152 to securely hold them to the main housing 7110. A functional device mount 7300 is mounted to the top of the telescoping mast 7160. Lights 7400 and 7401 are shown mounted to the mount 7300, and have electrical sockets 7410 for connection to the power cord 7130. Other types of functional device can be mounted to the mast. Further, the mast may include more than one mount, such as mount 7300, for greater flexibility of use. Further details of the functional device mount are provided with the subsequently in reference to FIGS. 65 and 66.

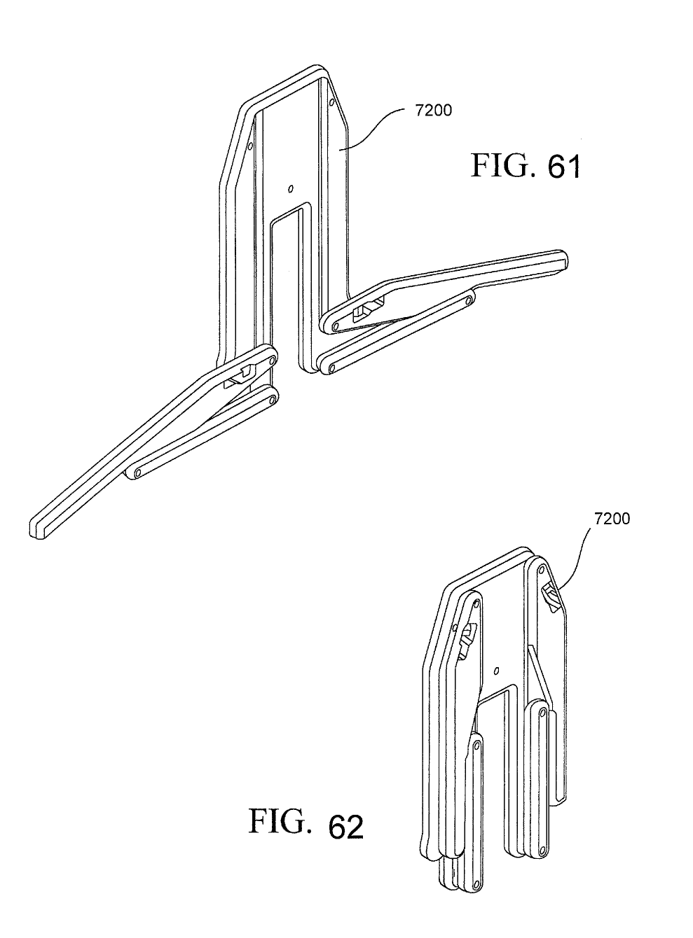

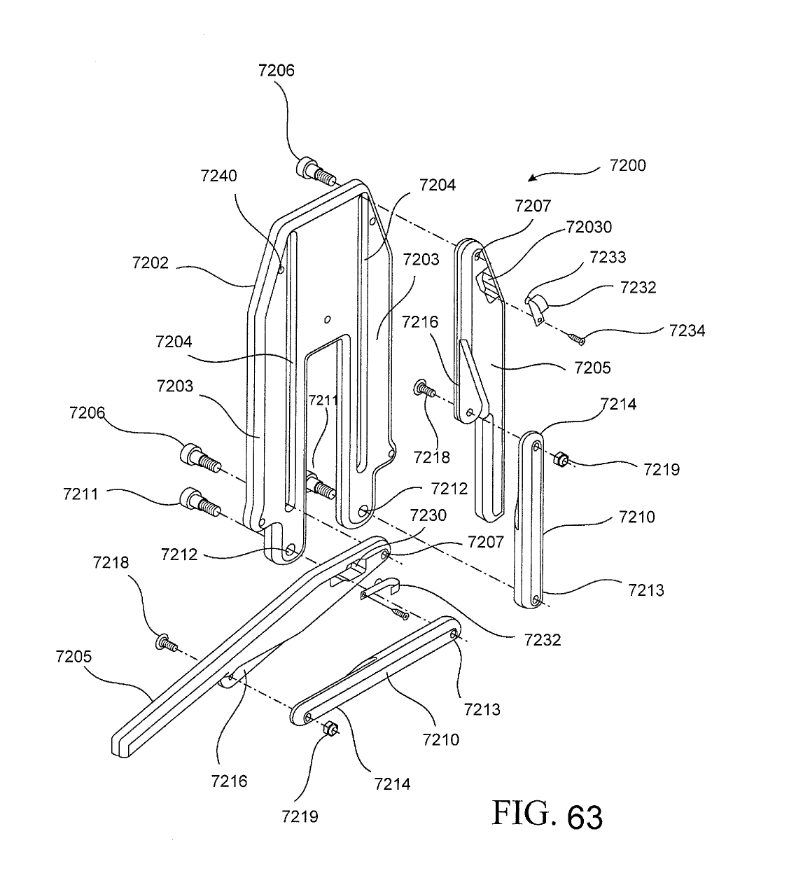

Referring to FIGS. 61 to 63, the leg assembly 7200 is shown in isolated form in its extended formation in FIG. 61, in its retracted formation in FIG. 62, and in an exploded view of its parts in FIG. 63. A main panel 7202 has two branches 7203 that extend downward in order for the panel 7202 to fit over the cord wrap protrusion 7215 on the housing. Extending vertically in both branches 7203 are elongated channels 7204; first and second legs 7205 are pivotally and slidably connected to the panel 7202 via bolts 7206 that pass through the channels 7204 to connect to upper mount holes 7207 in each leg. Bolts 7206 and others are shown as shoulder bolts, wherein the wide top portion cannot pass through a hole into which the threaded portion is inserted. First and second struts 7210 are pivotally mounted to panel 7202 via bolts 7211 that pass through mount holes 7212 in panel 7202 and mount holes 7213 on the inner portion of each strut 7210. Each strut 7210 is pivotally connected at its outer end 7214 to a flange 7216 on one of legs 7205; struts 7210 are connected to flanges 7216 by bolts 7218 and nuts 7219. Elongated channels 7204 permit the inner portions of legs 7205 to slide up and down, while struts 7210 limit the travel of the outer portions of the leg outward from the panel 7202. When legs 7205 are completely retracted so that the inner portion of each leg is near the top of the panel 7202 and the lower portion is adjacent the panel, the outer portion of each strut is vertically aligned above the inner portion of each strut (the inner and lower portions of each strut being pivotally mounted to mounting holes 7212 in panel 7202).

In order for the leg assembly to be locked into an open or retracted configuration, a biased push button mechanism is provided. Each leg 7205 has a T-slot 7230 in which is mounted a spring 7232 which has a button 7233. Screws 7234 are used to mount the springs to the legs 7205. Detents, such as detent 7240 on the panel 7202 engage with button 7233 to maintain the legs in the retracted position, while a lower detent in panel 7202 locks the legs in the extended position. By simply pressing on the spring with a finger, the legs will either retract or extend depending on the direction the legs are pushed. Bolts used may be of metal or other suitable material, while spring steel is recommended for spring 7232. The leg assembly can be made of a durable and robust plastic, similar or identical to that used in the main housing. A suitable spring for constructing a stand of size and robustness to hold a light 8 feet above ground is available from VALCO, of Ohio, part number F-224. Preferably the spring snap button has a J-shape or other configuration that will permit a finger to grasp it and pull it so that the button can be pulled free of a corresponding upper detent or lower detent in the mounting board, thereby permitting movement of the legs from being in a locked collapsed or locked extended configuration.

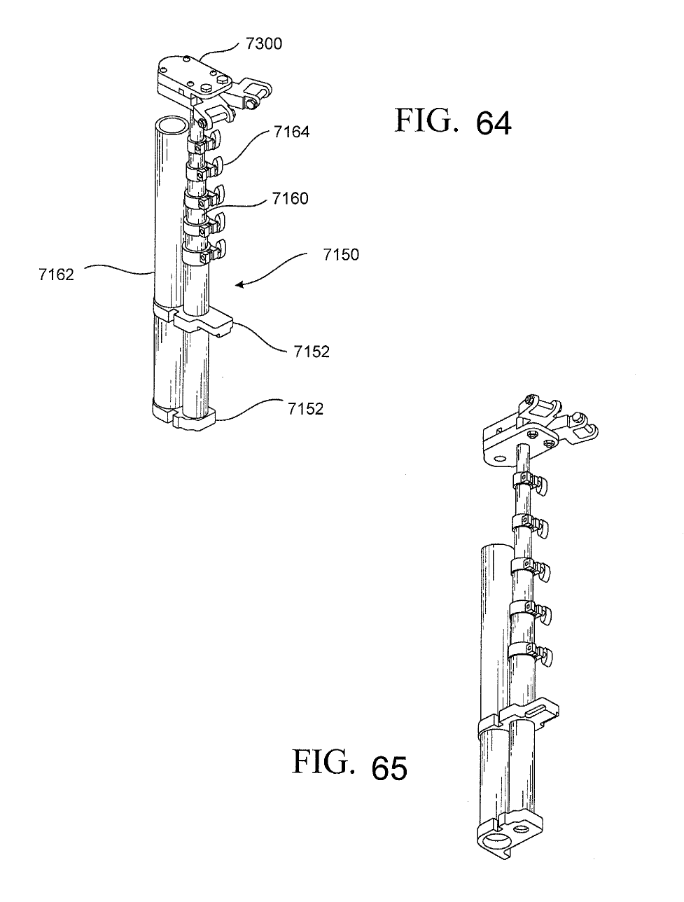

Referring to FIGS. 64 and 65, an isolated view of a mast assembly 7150 is shown from upper and lower perspectives. A telescoping mast 7160 is mounted adjacent to a cord protection sleeve 7162. The mast can be formed of aluminum, and a variety of masts are commercially available. Shown in FIGS. 64 and 65, wingnut assemblies 164 are shown that can be used to loosen and tighten connections between mast sections, however other adjustment mechanisms will also work. A preferred mast is extendable to 8 feet, while the legs can be extended to a total width of about 30 inches. The main housing forms a third legs of a tripod for supporting the mast. Extensions of the legs are envisioned are alternative extendable leg assemblies; for example, legs may retract into cavities in the housing, and the housing may include an outer shape that will fit around a functional device when retracted to protect the functional device.

Referring to FIG. 66, functional devices can be attached to mount 7300 by attachment to h-shaped brackets 7304. The h-shaped brackets 7304 can be pivotally mounted to mount 7300 via mounting holes 7305 and 7307. Mount 7300 includes an upper housing 7301, a lower housing 7302, and includes a fitting 7306 for attachment to the top of a mast. Fitting 7306 may be extended through the top of mount 7300 in an alternative embodiment to support a mast extension and other functional devices mounted thereon. FIG. 66 demonstrates how multiple lights can be mounted to the mast, for example LED lights that provide significant light while using less power. Preferably, a stand in accordance with the present invention will weigh less than 50 pounds, more preferably less than 40 pounds, while providing adequate portable power to supply lights meeting various road safety requirements (e.g., for road flaggers) and/or industrial requirements. Preferably the lights can be stably mounted at least 8 feet above the surface upon which the stand is set. For example, an 800 lumen LED light can provide overhead illumination for highway flaggers up to 200 yards or more. Further, with a charge source, the unit can be continuously charged at 115 VAC and light operations can continue while charging, for example an embodiment includes a 12 Volt power port for quick charge applications. Preferred LED Cube lights and bar lights are commercially available, and can be operated for at least 8 hours from the battery, with specifications set forth in Air Systems AIR LIGHT specifications, available from AIR SYSTEMS, INC., of Chesapeake, Va. USA.

The stabilizing base or main housing can be formed of polyethylene or other suitable robust material, while the housing for the power supply, control panel and mast mount can be of the same or other materials as are customary for such devices used in a variety of rigorous circumstances, for example, road lighting at night in construction zones, etc. In fact, in some circumstances, it is desired, if not required that lights be set up at a specific height to light traffic flaggers. The devices of the present inventions attached are ideally suited for holding lights at a height of at least about 8 feet from the ground, yet are light weight, durable, and easy to set up and collapse, making it an ideal lower cost yet robust portable platform for functional devices. Functional device can include for example a light, a microphone, a still camera, an audio output, a visual output, a laser, a weapon, a video camera, a transmitter, a receiver, a weather monitoring device, a solar panel, a surveying device, a motion sensing device, a chemical sensor, a thermal sensor, an alarm, a wind power generator, and a GPS device.

The details of certain embodiments of the present inventions have been described, which are provided as illustrative examples so as to enable those of ordinary skill in the art to practice the inventions. The description provided is not meant to limit the scope of the present inventions, but to be exemplary. The inventions are capable of other embodiments and of being practiced and carried out in various ways, and as such, those skilled in the art will appreciate that the conception upon which this disclosure is based may readily be utilized as a basis for the designing of other methods and systems for carrying out the several purposes of the present inventions. Where certain elements of the present inventions can be partially or fully implemented using known components, only those portions of such known components that are necessary for an understanding of the present invention are described, and detailed descriptions of other portions of such known components are omitted so as to avoid obscuring the invention. Further, the present invention encompasses present and future known equivalents to the components referred to herein.

While the preferred embodiments have been shown and described, it will be understood that there is no intent to limit the invention by such disclosure, but rather, is intended to cover all modifications and alternate constructions falling within the spirit and scope of the invention.

1. A portable stand comprising:
a plastic case that defines an enclosed space and having at least two sides, a mast operatively connected to said case, a mast mount for attaching at least one functional device to said mast, extendible and retractable first and second legs, said first and second legs both being operatively connected to at least one of said two sides of said case so that said first and second legs can be locked in a retracted or extended position, and said mast operatively connected to one of said at least two sides of said case such that said mast is selectively extended and retracted from said case,
said case providing said enclosed space in which a power supply and a control panel can be contained, wherein when present the power supply comprises a battery,
said mast mount being operatively connected to said mast, wherein said first and second legs may be retracted for transport and storage and said mast can be retracted for transport and storage, said first and second legs and said mast being extendable from said case at a site of use by manipulation of said first and second legs and said mast without requiring connection of parts thereto, wherein said mast can be extended vertically from said case and said first and second legs can be extended horizontally from said case, and wherein said case forms a third leg of a tripod in conjunction with the first and second legs when the first and second legs are in their horizontally extended position providing stability for said mast when said mast is extended vertically upwards from said case.

2. The portable stand of claim 1, further comprising a functional device selected from the group consisting of a light, a microphone, a still camera, an audio output, a visual output, a laser, a weapon, a video camera, a transmitter, a receiver, a weather monitoring device, a solar panel, a surveying device, a motion sensing device, a chemical sensor, a thermal sensor, an alarm, a wind power generator, and a GPS device.

3. The portable stand of claim 1, wherein said first and second legs are operatively attached to said case so that said first and second legs can be locked in a retracted or extended position via pivotal and sliding motion.

4. The portable stand of claim 1, further comprising a cord protection sleeve adjacent said mast for protecting a power cord that can extend from said case to said mast mount or to the at least one functional device when the at least one functional device is operatively connected to said mast mount.

5. The portable stand of claim 1, further comprising a control for at least one of the power supply or the at least one functional device when connected to said stand.

6. A portable stand including a supporting frame, said supporting frame comprising:
a base assembly operatively connectable to at least one extendible leg for movement of the at least one leg, when connected, about a pivotal axis, said base assembly comprising a base plate operatively connectable to an interior of a case, wherein at least one extendible leg can be individually and pivotally attached to said base plate for selective retraction for storage inside of the interior of a case to which said base plate is attached, and said base plate comprises a releasable locking member for controlling angular orientation of at least one extendible leg when operatively connected to said base assembly; and
a telescoping mast assembly comprising a mast support bracket assembly operatively connectable to the interior of a case, said telescoping mast assembly is operatively connectable to a telescopically extendible mast so that when a mast is connected the mast can be selectively retracted for storage inside of the interior of a case, wherein said mast support bracket assembly comprises a releasable locking member for controlling angular orientation of the telescopically extendible mast when operatively connected to a mast mount for at least one functional device;
wherein when at least one extendible leg is attached to said base assembly, the at least one leg can be pivoted about 90 degrees with respect to said base assembly and a telescopically extendible mast, when attached to said telescoping mast assembly, can be pivoted about 180 degrees with respect to said telescoping mast assembly, wherein when the telescopically extendible mast, when present, is pivoted inward toward said base assembly and the at least one extendible leg, when present, is pivoted inward toward said telescoping mast assembly a cover on the case can be closed to enclose the at least one extendible leg and the telescoping mast assembly within the interior of the case.

7. The portable stand including said supporting frame of claim 6, further comprising at least one extendible leg operatively connected to said base assembly.

8. The portable stand including said supporting frame of claim 7, further comprising a telescopically extendible mast operatively connected to said telescoping mast assembly.

9. The portable stand including said supporting frame of claim 8, wherein said releasable locking member of said mast support bracket assembly operatively connects said mast support assembly and said telescopically extendible mast controlling angular orientation of the said telescopically extendible mast.

10. The portable stand including said supporting frame of claim 8, wherein said releasable locking member of said base plate operatively connects said at least one extendible leg and said base assembly controlling angular orientation of said at least one extendible leg.

11. The portable stand including said supporting frame of claim 10, wherein said releasable locking member of said mast support bracket assembly operatively connects said mast support assembly and said telescopically extendible mast controlling angular orientation of the said telescopically extendible mast.

12. A portable stand comprising:
a case that defines an enclosed space in which a power supply and a controller are mounted;
a mount for attaching at least one functional device;
extendible and retractable first and second legs pivotally attached to said case for rotation about a substantially horizontal axis, said first and second legs being attached to said case so that said first and second legs can be locked in a retracted position for transport and storage or an extended position for use at a site of operation, wherein said case forms a third leg of a tripod in conjunction with the first and second legs when the first and second legs are in their extended position; and
an extendible mast to which said mount is connected, said extendible mast being attached to said case such that said extendible mast can be retracted for transport and can be extended vertically upwards from said case.

13. The portable stand of claim 12, wherein a longitudinal axis of said extendible mast coincides with a center of the tripod formed by the case, the first leg and the second leg.

14. The portable stand of claim 12, further comprising a functional device selected from the group consisting of a light, a microphone, a still camera, an audio output, a visual output, a laser, a weapon, a video camera, a transmitter, a receiver, a weather monitoring device, a solar panel, a surveying device, a motion sensing device, a chemical sensor, a thermal sensor, an alarm, a wind power generator, and a GPS device.

15. The portable stand of claim 12, further comprising a cord protection sleeve adjacent said extendible mast for protecting a power cord that can extend from said case to said mount or to the at least one functional device when the at least one functional device is operatively connected to said mount, wherein said controller controls said power supply, wherein, when the at least one functional device is attached to said mount, power from said power supply can be supplied to the at least one functional device and said controller can control power supplied to the at least one functional device from said power supply and said mount provides for pivotal movement of the at least one functional device about multiple axes.

16. The portable stand of claim 15, further comprising:
a mast attachment fitting permitting a mast extension to be mounted to said extendible mast,
a first functional device that is an electrical light and a second functional device that is as electrical light, both said first functional device and said second functional device being held by said mount,
said mount includes a center bracket comprising an integrated electrical box, a first pivot mount having a socket about which a first functional device pivots, and a second pivot mount having a socket about which a second functional device pivots, wherein said mount provides for pivotal movement about a first axis, a second axis, a third axis, a fourth axis, and a fifth axis, and wherein said first axis is perpendicular to said second axis, said first axis is perpendicular to said third axis, said second axis is perpendicular to said fourth axis and said third axis is perpendicular to said fifth axis.

17. The portable stand of claim 12, wherein said mount comprises:
a center bracket that can be attached to an upper end of said extendible mast and provides for said mount to pivot about a first axis;
a first pivot mount that is connected to said center bracket, said first pivot mount permitting a first functional device when mounted therein to pivot about a second axis at an angle to said first axis; and
a second pivot mount that is connected to said center bracket, said second pivot mount permitting a second functional device when mounted therein to pivot about a third axis that is at an angle to said first axis;
said first and second pivot mounts both comprising a rotational mount pivotally mounted therein, wherein the first functional device when mounted in said first pivot mount rotates about a fourth axis and the second functional device when mounted in said second pivot mount rotates about a fifth axis, wherein the first and second functional devices mounted in said first and second pivot mounts respectively can rotate and pivot independently of each other.
